(19) United States
(12) Patent Application Publication
(10) Pub. No.: US 2009/0011213 A1
(43) Pub. Date: Jan. 8, 2009

(54) Recyclable Multilayer Thermoplastic Films and Methods of Making

(75) Inventor: Sandeep Tripathi, Evansville, IN (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 11/773,038

(22) Filed: Jul. 3, 2007

(51) Int. Cl. B32B 27/36; B29C 47/06; B32B 17/02; B29C 45/16

(52) U.S. Cl. 428/293.4; 264/171.1; 264/173.16; 428/412; 264/241

(57) ABSTRACT

A thermoplastic multilayer film includes an outer layer comprising a polymer comprising resorcinol arylate polyester chain members, and a base layer comprising about 2 wt % to about 98 wt % of an aromatic carbonate polymer or copolymer, and about 2 wt % to about 98 wt % of a polymer copolymer derived from a glycol portion comprising 1,4 cyclohexanedimethanol and ethylene glycol wherein the molar ratio of 1,4 cyclohexanedimethanol to ethylene glycol is about 1:1 to about 4:1, and an acid portion comprising an aromatic dicarboxylic acid.

### BACKGROUND

Thermoplastic films for automotive exterior applications are expected to meet multiple, stringent aesthetics, physical, chemical requirements that are typically not all met by a single polymer. Therefore, most of these articles are multilayered, wherein each layer fulfills a certain set of requirements. Thermoformable multilayer films are known in the vehicular arts as providing acceptable surface preparation when applied to various automobile components without distorting the quality of the underlying surface or substrate. However, existing laminates have known to show inter-layer or intra-layer separations, including separations from substrates bonded to the laminates. Moreover, the various layers of the multilayer films compositions can adhere unevenly to each other and/or the surface of substrate to which they are applied. This can result in unacceptable surface qualities in the finished automotive part.

One challenge in producing current multilayer films is to ensure thermodynamic compatibility between individual layers and with the substrate to prevent delamination at any of the multiple interfaces in the final structure. As such, the choice of resin chemistry becomes critical. The existing structure for multilayer automotive laminate films is a 3-layer design, wherein the third layer serves the sole purpose of acting as the tie-layer between the film and the substrate. Currently, the adhesion of this tie-layer to the substrate leaves significant room for improvement.

Even further, the need for multiple layers of film to meet the myriad of requirements for automotive applications negatively impacts process yield. Typical production of extruded films is accompanied by generation of a certain amount of unusable product or ‘scrap’. Factors such as trim losses (final web width required by the customer is different from extruded web), start-up losses, contamination, raw material quality, process upsets, mechanical failures on the line, and the like all contribute to the size of scrap generated during production. For most monolayer films with relaxed aesthetics requirements, the scrap can be grounded and mixed with the virgin resin and fed back into the line. When the film is multilayered, as is the case with laminates for automotive exteriors, wherein each layer adds a unique value, miscibility problems arise between the different polymer layers and prohibit efficient recyclability. Because of the largely dissimilar properties between the layers, the resins are generally non-miscible. The greater the number of layers, the more compounded the problem becomes. The immiscibility prevents recycling of the scrap and negatively impacts the yield. Moreover, if an appropriate alternate outlet is not found for the scrap, it often goes to the landfill, wherein environmental implications arise.

Therefore, there continues to be a need for multilayer thermoplastic film compositions that more effectively adhere to substrate surfaces. Further, there is a need for such multilayer thermoplastic film compositions comprising miscible layers that permit process scrap to be recycled, thereby improving production yields and reducing environmental impact.

### BRIEF DESCRIPTION

Disclosed herein an article including a thermoplastic multilayer film comprising an outer layer comprising a polymer comprising resorcinol arylate polyester chain members, and a base layer comprising 2 wt % to 98 wt % of an aromatic carbonate polymer or copolymer, and 2 wt % to 98 wt % of a polymer copolymer derived from a glycol portion comprising 1,4 cyclohexanedimethanol and ethylene glycol wherein the molar ratio of 1,4 cyclohexanedimethanol to ethylene glycol is from about 1:1 to about 4:1, and an acid portion comprising an aromatic dicarboxylic acid.

A method of making an article, includes placing a thermoplastic multilayer film into a mold so that a cavity is formed behind the multilayer film, wherein the thermoplastic multilayer film comprises an outer layer comprising a polymer comprising resorcinol arylate polyester chain members, and a base layer comprising 2 wt % to 98 wt % of an aromatic carbonate polymer or copolymer, and 2 wt % to 98 wt % of a polymer copolymer derived from a glycol portion comprising 1,4 cyclohexanedimethanol and ethylene glycol wherein the molar ratio of 1,4 cyclohexanedimethanol to ethylene glycol is from about 1:1 to about 4:1, and an acid portion comprising an aromatic dicarboxylic acid selected from the group consisting essentially of terphthalic acid, isophthalic acid, and mixtures of the foregoing acids, placing a substrate into the cavity, and adhering the base layer to the substrate to form the article.

The above-described and other features will be appreciated and understood from the following detailed description, drawings, and appended claims.

### DETAILED DESCRIPTION OF THE DRAWINGS

Referring now to the figures, which are exemplary embodiments, and wherein like elements are numbered alike:

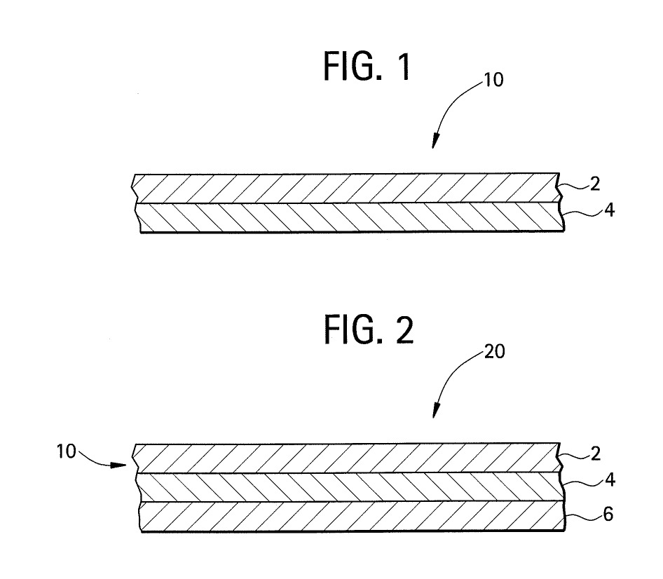

FIG. 1 is a cross-sectional view of an exemplary embodiment of a thermoplastic multilayer film;

FIG. 2 is a cross-sectional view of an exemplary embodiment of a an article comprising a thermoplastic multilayer film adhered to a substrate;

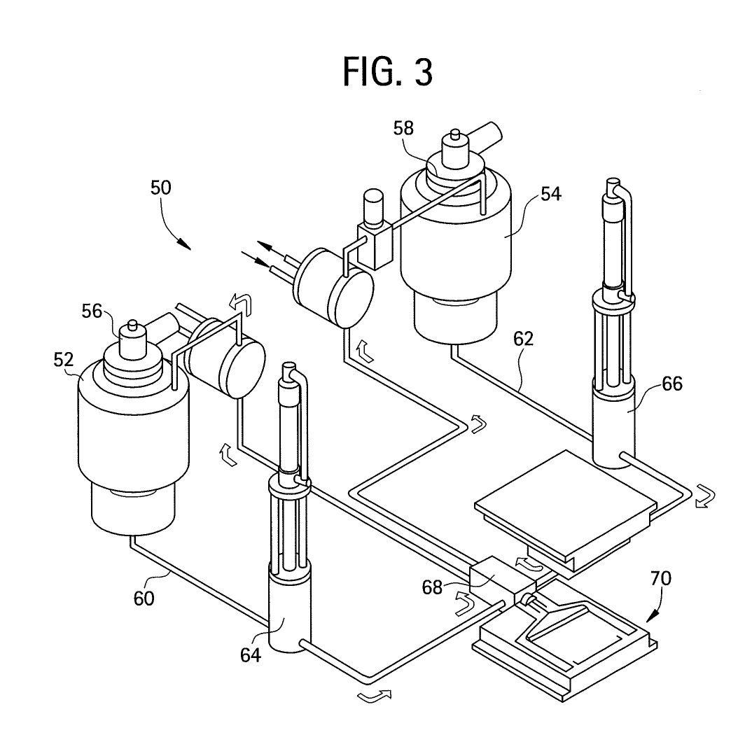

FIG. 3 is a schematic diagram illustrating an exemplary embodiment of a substrate backmolding process;

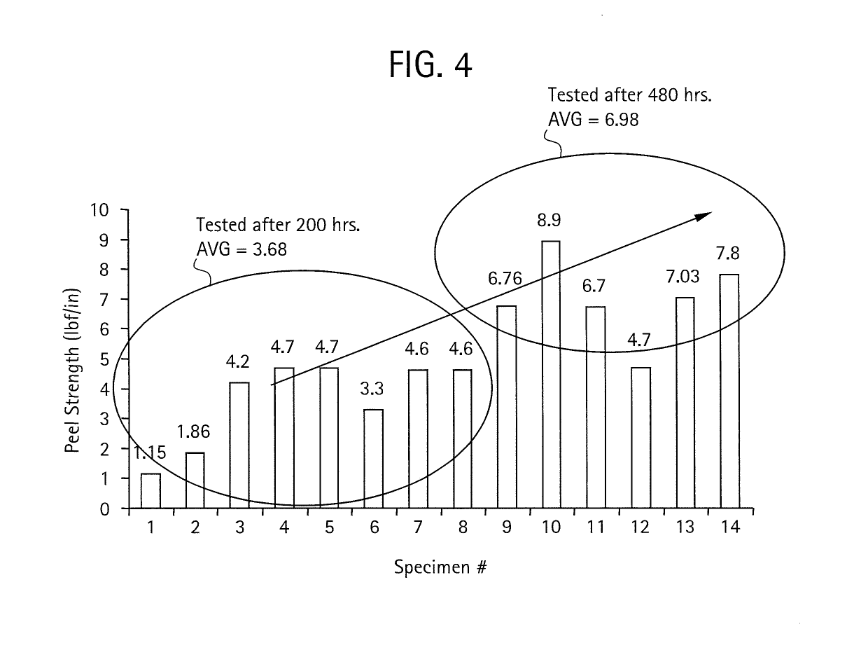

FIG. 4 is a bar chart of adhesion strength for the samples as created in Example 1;

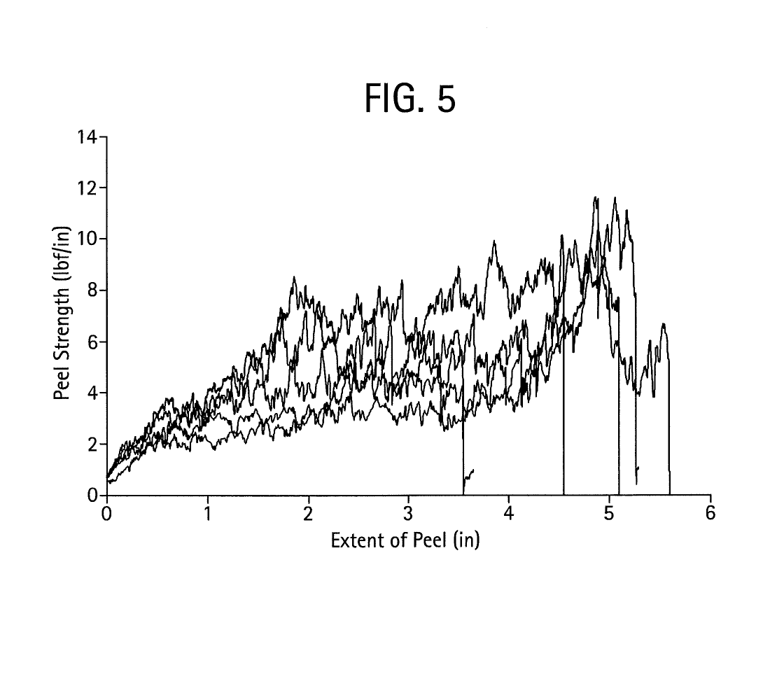

FIG. 5 is an Instron plot showing the peel strength versus extent of peel for the samples created in Example 1;

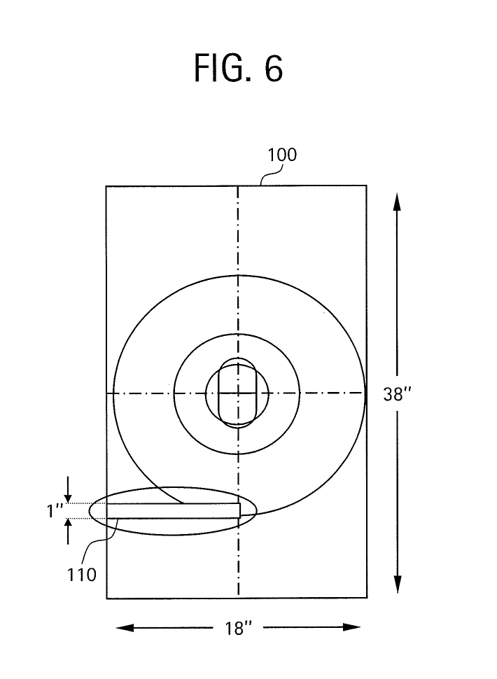

FIG. 6 is an example of a molded plaque and the orientation of a test sample as created in Example 1;

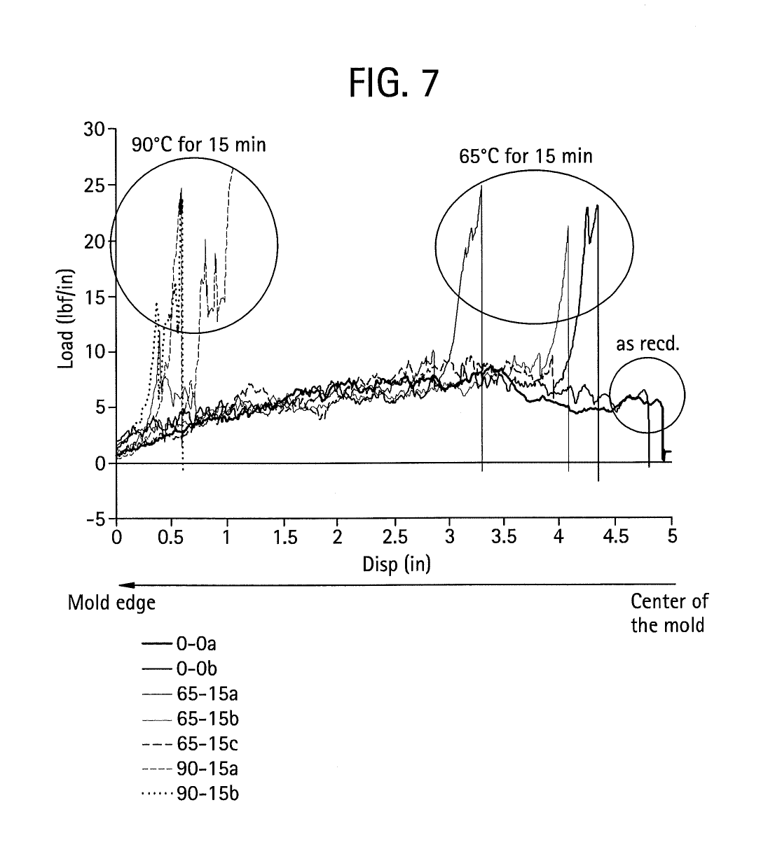

FIG. 7 is another Instron plot showing adhesion strength versus displacement across the test samples created in Example 1;

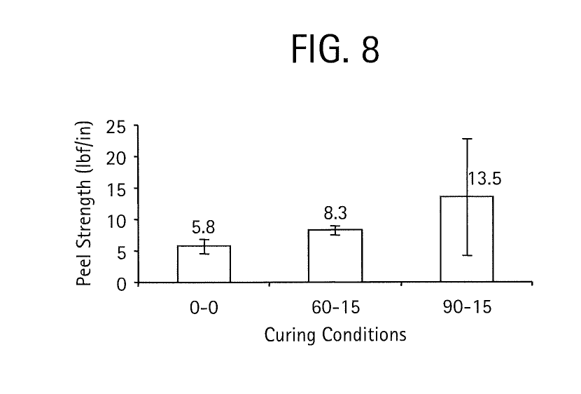

FIG. 8 is a bar chart representing average adhesion values for the samples created in Example 1;

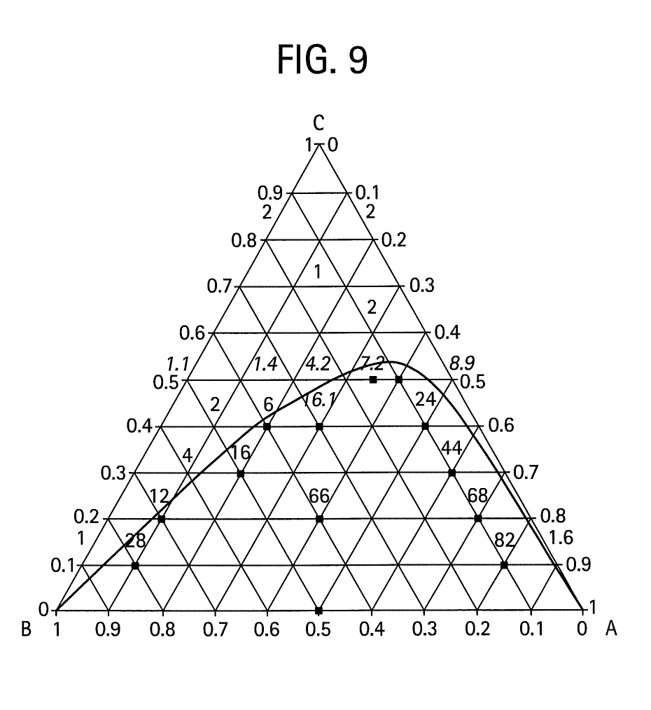

FIG. 9 is a ternary diagram showing the mapped phase space of the outer layer and the base layer of an exemplary thermoplastic multilayer film as tested in Example 2;

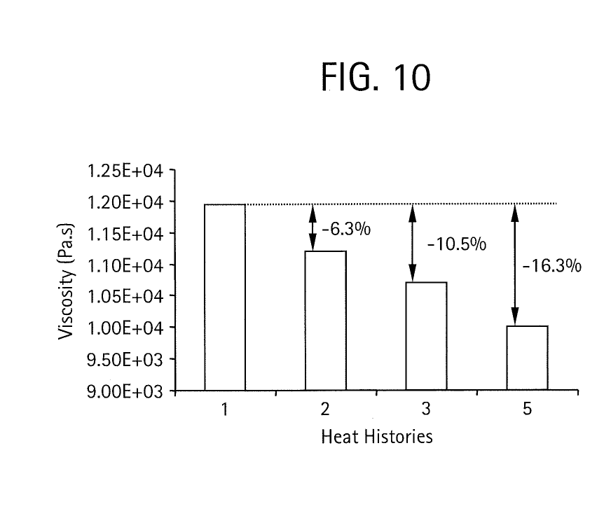

FIG. 10 is a bar chart representing viscosity values for virgin base layer resin of various heat histories as tested in Example 2;

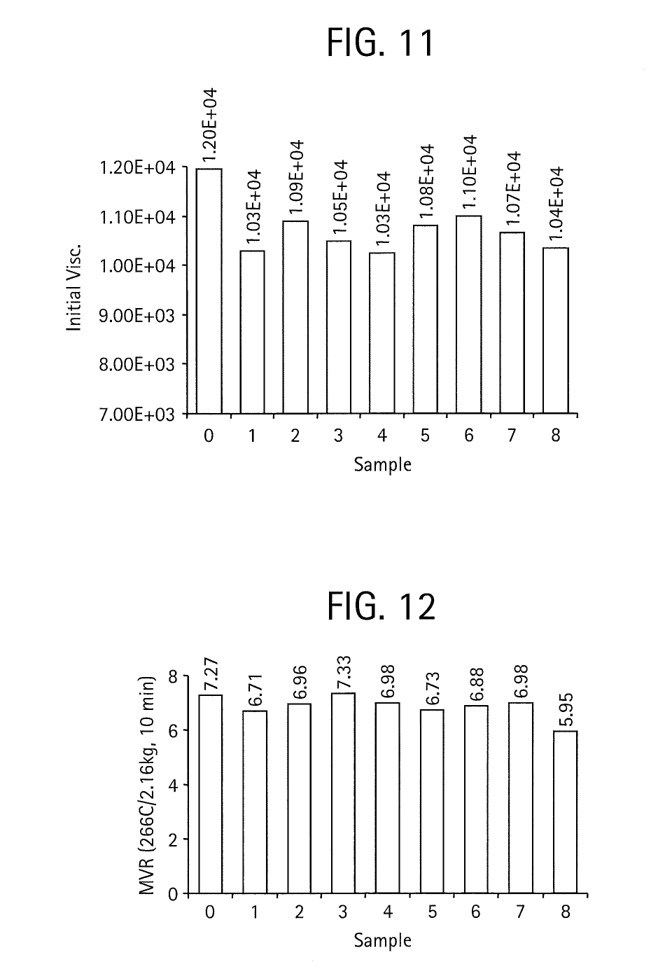

FIG. 11 is a bar chart representing initial viscosity of various sample formulations as tested in Example 2;

FIG. 12 is a bar chart representing melt volume rates of various sample formulations as tested in Example 2;

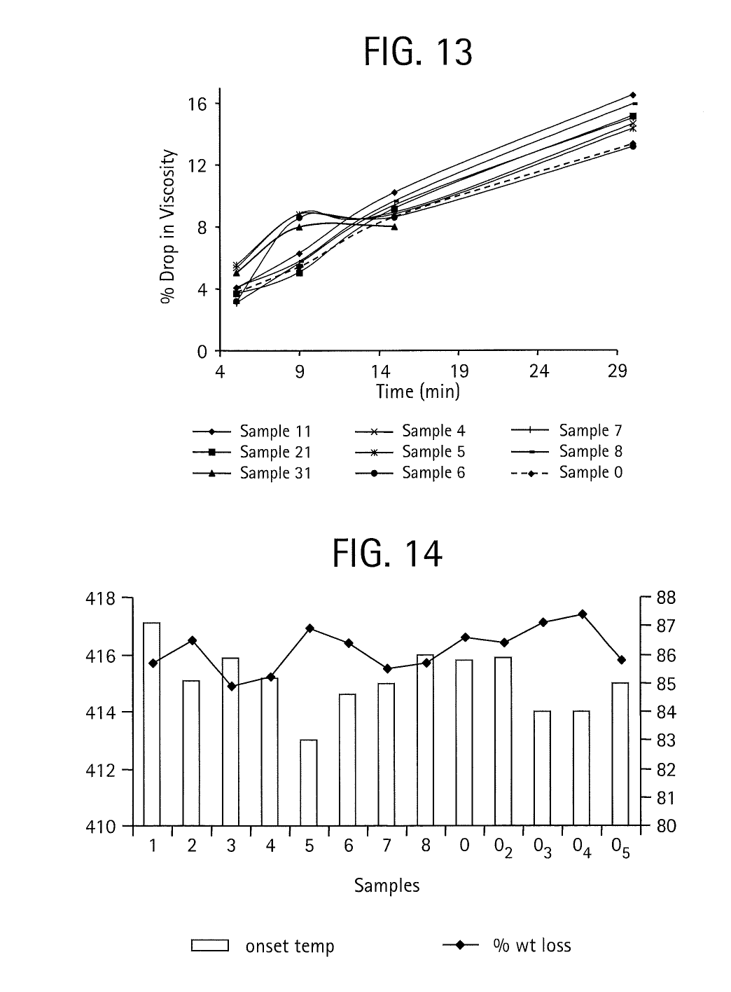

FIG. 13 is a graph representing viscosity drop versus time of various sample formulations as tested in Example 2;

FIG. 14 is a bar chart representing percent weight loss and the onset temperature of the weight loss of various sample formulations as tested in Example 2;

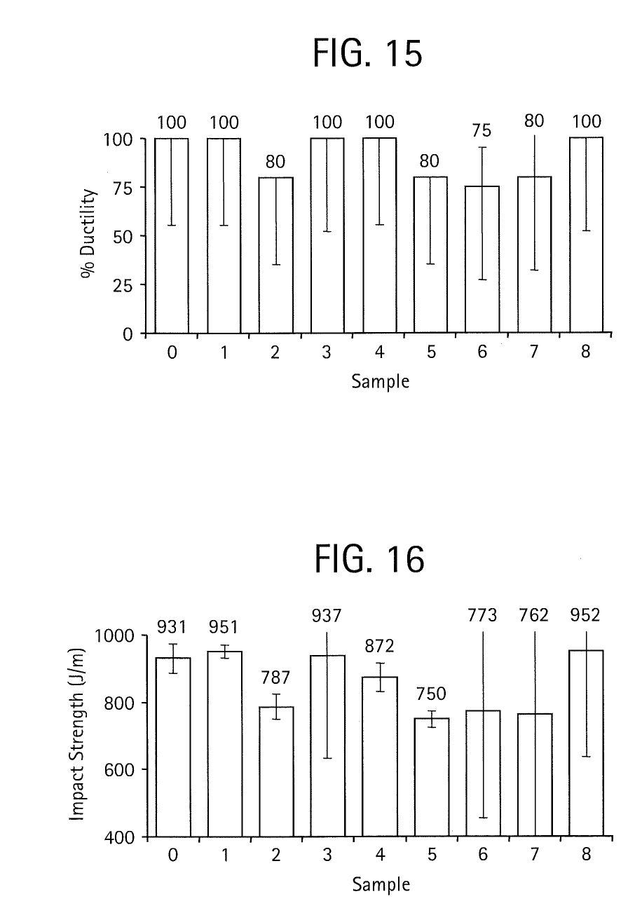

FIGS. 15 and 16 are bar charts representing the percent ductility and impact strength of notched-IZOD test samples of various formulations as tested in Example 2; and

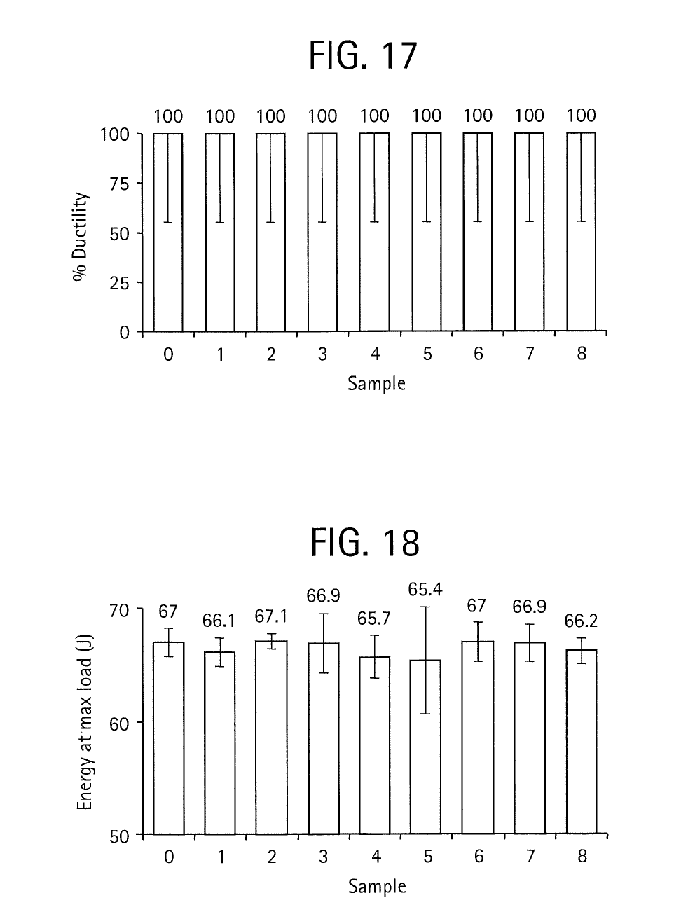

FIGS. 17 and 18 are bar charts representing the percent ductility and energy at maximum deflection of Dynatup disk test samples of various formulations as tested in Example 2.

### DETAILED DESCRIPTION

In one embodiment, a thermoplastic multilayer film having improved adhesion to a substrate is disclosed. In another embodiment, a thermoplastic multilayer film is disclosed wherein the individual layers are miscible, thereby offering the opportunity to recycle production scrap and increase yield gains.

The thermoplastic multilayer film, as disclosed herein, eliminates the need for the tie-layer, which is used to adhere the middle and outer layers of current multilayer films to a substrate. Removing the layer, therefore, simplifies the design, and hence the resulting manufacturing. The removal of the tie-layer is achieved through choice of chemistry of the base layer, which not only provides superior adhesion, but also shows an unexpected improvement in adhesion with time. Moreover, the same base layer is miscible with the outer layer, thereby offering the opportunity to recycle the scrap generated during production.

The thermoplastic multilayer film as disclosed herein comprise at least two layers. Multilayer articles can further comprise a substrate layer which includes a thermoplastic material. FIG. 1 illustrates a cross-sectional view of the disclosed thermoplastic multilayer film 10. The thermoplastic multilayer film 10 comprises an outer layer 2 and a base layer 4, opposite the outer layer 2.

In one exemplary embodiment, the outer layer 2 comprises a polymer comprising resorcinol polyester chain members, the base layer 4 comprises a blend of aromatic polycarbonate and a copolymer derived from a glycol portion comprising 1,4 cyclohexanedimethanol and ethylene glycol and an acid portion comprising an aromatic dicarboxylic acid selected from the group consisting essentially of terephthalic acid, isophthalic acid, and mixtures of the foregoing acids.

In one embodiment, the outer layer 2 of the thermoplastic multilayer film 10 will comprise polymer(s) comprising resorcinol arylate polyester chain members.

“Resorcinol arylate polyester chain members” as used herein refers to chain members that comprise diphenol residue(s) in combination with aromatic diphenol residue(s) in combination with aromatic dicarboxylic acid residue(s). The diphenol residue, illustrated in Formula I, is derived from a 1,3 dihydroxybenzene moiety, commonly referred to throughout this specification as resorcinol or rescorcinol moiety. Resorcinol or resorcinol moiety as used herein should be understood to include both unsubstituted 1,3-dihydroxybenzene and substituted 1,3-dihydroxybenzene unless explicitly stated otherwise.

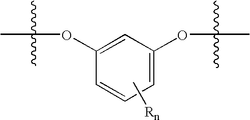

wherein R is of C₁₋₁₂ alkyl(s) and/or halogen(s), and n is 0-3.

Exemplary dicarboxylic acid residues include aromatic dicarboylic acid residues derived from monocyclic moieties (e.g., isophthalic acid, terephthalic acid, and combinations comprising at least one of the foregoing), or from polycyclic moieties, including diphenyl dicarbonxylic acid, diphenyl ether dicarboxylic acid, naphthalenedicarboxylic acid such as naphthalene-2,6-dicarboxylic acid, and morphthalene dicarbonxylic acid such as morphthalene 2,6-dicarbonxylic acid. In one embodiment, the dicarboxylic acid residue used will be 1,4-cyclohexanedicarboxylic acid residue.

In one exemplary embodiment, the aromatic discarboxylic acid residues will be derived from mixtures of isophthalic and/or terephthalic acids as illustrated in Formula II.

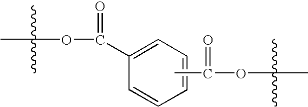

In one exemplary embodiment, the outer layer 2 will comprise a polymer as illustrated in Formula III wherein R and n are as previously defined:

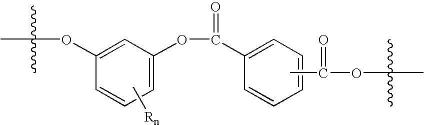

In one exemplary embodiment, the outer layer 2 will comprise a polymer having resorcinol arylate polyester chain members that are substantially free of anhydride linkages as are illustrated in Formula IV:

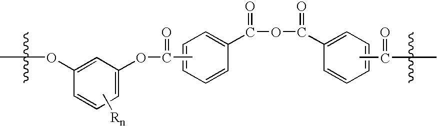

In one exemplary embodiment, outer layer 2 will comprise a polymer comprising resorcinol arylate polyester chain members made by an interfacial method comprising a first step of combining resorcinol moiety(ies) and catalyst(s) in a mixture of water and organic solvent(s) substantially immiscible with water. Exemplary resorcinol moieties comprise units of Formula V:

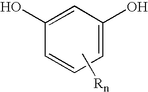

wherein R is C₁₋₁₂ alkyl(s) and/or halogen(s), and n is 0-3. Alkyl groups, if present, can be straight-chain or branched alkyl groups, and are most often located in the ortho position to both oxygen atoms although other ring locations are contemplated. Exemplary C₁₋₁₂ alkyl groups include methyl, ethyl, n-propyl, isopropyl, butyl, iso-butyl, t-butyl, nonyl, decyl, and aryl-substituted alkyl, including benzyl, and combinations comprising at least one of the foregoing. Exemplary halogen groups are bromo, chloro, and fluoro. The value for n can be 0-3, specifically 0-2, and more specifically 0-1. The resorcinol moiety can be 2-methylresorcinol, or, desirably, an unsubstituted resorcinol moiety in which n is zero.

In one exemplary embodiment, catalyst(s) will be combined with the reaction mixture used in the interfacial method of polymerization. The catalyst can be present at a total level of 0.1 to 10 mole %, and specifically 0.2 to 6 mole % based on total molar amount of acid chloride groups. Exemplary catalysts comprise tertiary amines, quaternary ammonium salts, quaternary phosphonium salts, hexaalkylguanidinium salts, and mixtures thereof. Exemplary tertiary amines include triethylamine, dimethylbutylamine, diisopropylethylamine, 2,2,6,6-tetramethylpiperidine, and combinations comprising at least one of the foregoing. Other contemplated tertiary amines include N—C₁-C₆-alkyl-pyrrolidines, such as N-ethylpyrrolidine, N—C_{l -C}₆-piperidines, such as N-ethylpiperidine, N-methylpiperidine, and N-isopropylpiperidine, N—C₁-C₆-morpholines, such as N-ethylmorpholine and N-isopropyl-morpholine, N—C₁-C₆-dihydroindoles, N—C₁-C₆-dihydroisoindoles, N—C₁-C₆-tetrahydroquinolines, N—C₁-C₆-tetrahydroisoquinolines, N—C₁-C₆-benzo-morpholines, 1-azabicyclo-[3.3.0]-octane, quinuclidine, N—C₁-C₆-alkyl-2-azabicyclo-[2.2.1]-octanes, N—C₁-C₆-alkyl-2-azabicyclo-[3.3.1]-nonanes, and N—C₁-C₆-alkyl-3-azabicyclo-[3.3.1]-nonanes, N,N,N′, N′-tetraalkylalkylene-diamines, including N,N,N′,N′-tetraethyl-1,6-hexanediamine, and combinations comprising at least one of the foregoing. In some embodiments, the tertiary amines are triethylamine and N-ethylpiperidine.

When the catalyst comprises tertiary amine(s) alone, then the catalyst can be present at a total level of 0.1 to 10 mole %, specifically 0.2 to 6 mole %, more specifically 1 to 4 mole %, and most specifically 2.5 to 4 mole % based on total molar amount of acid chloride groups. In one embodiment all of the tertiary amine(s) are present at the beginning of the reaction before addition of dicarboxylic acid dichloride to resorcinol moiety. In another embodiment a portion of any tertiary amine is present at the beginning of the reaction and a portion is added following or during addition of dicarboxylic acid dichloride to resorcinol moiety. In this latter embodiment the amount of any tertiary amine initially present with resorcinol moiety can be about 0.005 wt. % to about 10 wt. %, specifically about 0.01 wt % to about 1 wt. %, and more specifically about 0.02 to about 0.3 wt. % based on total amine.

Exemplary quaternary ammonium salts, quaternary phosphonium salts, and hexaalkylguanidinium salts include halide salts such as tetraethylammonium bromide, tetraethylammonium chloride, tetrapropylammonium bromide, tetrapropylammonium chloride, tetrabutylammonium bromide, tetrabutylammonium chloride, methyltributylammonium chloride, benzyltributylammonium chloride, benzyltriethylammonium chloride, benzyltrimethylammonium chloride, trioctylmethylammonium chloride, cetyldimethylbenzylammonium chloride, octyltriethylammonium bromide, decyltriethylammonium bromide, lauryltriethylammonium bromide, cetyltrimethylammonium bromide, cetyltriethylammonium bromide, N-laurylpyridinium chloride, N-laurylpyridinium bromide, N-heptylpyridinium bromide, tiicaprylylmethylammonium chloride (sometimes known as ALIQUAT 336), methyltri-C₈-C₁₀-alkyl-ammonium chloride (sometimes known as ADOGEN 464), N,N,N′,N′,N′-pentaalkyl-alpha, omega-amineammonium salts such as disclosed in U.S. Pat. No. 5,821,322; tetrabutylphosphonium bromide, benzyltiphenylphosphonium chloride, triethyloctadecylphosphonium bromide, tetraphenylphosphonium bromide, triphenylmethylphosphonium bromide, trioctylethylphosphonium bromide, cetyltriethylphosphonium bromide, hexaalkylguanidinium halides, hexaethylguanidinium chloride, and the like, and combinations comprising at least one of the foregoing.

Organic solvents substantially immiscible with water include those that are less than about 5 wt. %, and specifically less than about 2 wt. % soluble in water under the reaction conditions. Exemplary organic solvents include dichloromethane, trichloroethylene, tetrachloroethane, chloroform, 1,2-dichloroethane, toluene, xylene, trimethylbenzene, chlorobenzene, o-dichlorobenzene, and combinations comprising at least one of the foregoing. An especially preferred solvent is dichloromethane.

Exemplary dicarboxylic acid dichlorides comprise aromatic dicarboxylic acid dichlorides derived from monocyclic moieties, specifically isophthaloyl dichloride, terephthaloyl dichloride, or mixtures of isophthaloyl and terephthaloyl dichlorides, or from polycyclic moieties, including diphenyl dicarboxylic acid dichloride, diphenylether dicarboxylic acid dichloride, and naphthalenedicarboxylic acid dichloride, specifically naphthalene-2,6-dicarboxylic acid dichloride; or from mixtures of monocyclic and polycyclic aromatic dicarboxylic acid dichlorides. The dicarboxylic acid dichloride can comprise mixtures of isophthaloyl and/or terephthaloyl dichlorides as typically illustrated in Formula VI.

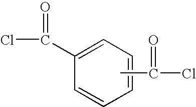

Either or both of isophthaloyl and terephthaloyl dichlorides can be used to make the polymer comprised in the outer layer 2. In one embodiment, the dicarboxylic acid dichlorides comprise mixtures of isophthaloyl and terephthaloyl dichloride in a molar ratio of isophthaloyl to terephthaloyl of (about 0.25 to about 4.0):1, in another embodiment, (about 0.4 to about 2.5):1, and in one exemplary embodiment, (about 0.67 to about 1.5):1.

The pH of the interfacial reaction mixture is maintained at about 3 and about 8.5 in one embodiment, and about 5 and about 8 in another embodiment, throughout addition of the dicarboxylic acid dichloride(s) to the resorcinol moiety(ies). Exemplary reagents to maintain the pH include alkali metal hydroxides, alkaline earth hydroxides, and alkaline earth oxides, or, specifically, potassium hydroxide and sodium hydroxide. The reagent to maintain pH can be included in the reaction mixture in any convenient form. In one embodiment, the reagent is added to the reaction mixture as an aqueous solution simultaneously with the dicarboxylic acid dichloride(s).

The temperature of the interfacial reaction mixture can be any convenient temperature that provides a rapid reaction rate and a resorcinol arylate-containing polymer substantially free of anhydride linkages. Convenient temperatures include those of about −20° C. to the boiling point of the water-organic solvent mixture under the reaction conditions. In one embodiment, the reaction is performed at the boiling point of the organic solvent in the water-organic solvent mixture. In one exemplary embodiment the reaction is performed at the boiling point of dichloromethane.

The total molar amount of acid chloride groups added to the reaction mixture is stoichiometrically deficient relative to the total molar amount of phenolic groups. The stoichiometric ratio is desirable so that hydrolysis of acid chloride groups is minimized, and so that nucleophiles such as phenolic and/or phenoxide can be present to destroy any adventitious anhydride linkages, should any form under the reaction conditions. The total molar amount of acid chloride groups includes the dicarboxylic acid dichloride(s), and any mono-carboxylic acid chloride chain-stoppers and any tri- or tetra-carboxylic acid tri- or tetra-chloride branching agents which can be used. The total molar amount of phenolic groups includes resorcinol moieties, and any mono-phenolic chain-stoppers and any tri- or tetra-phenolic branching agents that can be used. The stoichiometric ratio of total phenolic groups to total acid chloride groups can be (about 1.5 to about 1.01):1, and more specifically (about 1.2 to about 1.02):1.

The presence or absence of anhydride linkages following complete addition of the dicarboxylic acid dichloride(s) to the resorcinol moiety(ies) will typically depend upon the exact stoichiometric ratio of reactants and the amount of catalyst present, as well as other variables. For example, if a sufficient molar excess of total phenolic groups is present, anhydride linkages are often found to be absent. Often a molar excess of at least about 1%, and in one embodiment, at least about 3%, of total amount of phenolic groups over total amount of acid chloride groups can suffice to eliminate anhydride linkages under the reaction conditions. When anhydride linkages can be present, it is often desirable that the final pH be greater than 7 so that nucleophiles such as phenolic, phenoxide and/or hydroxide can be present to destroy any anhydride linkages. Therefore, in one embodiment, the interfacial method used to provide the polymer of the sub-layer(s) of the outer layer 2 can further comprise the step of adjusting the pH of the reaction mixture to 7 to 12, in one embodiment, and 8 to 12, and in another embodiment, 8.5 to 12, following complete addition of the dicarboxylic acid dichloride(s) to the resorcinol moiety(ies). The pH can be adjusted by any convenient method, such as using an aqueous base such as aqueous sodium hydroxide.

Provided the final pH of the reaction mixture is greater than or equal to 7, the interfacial method used to provide the polymer comprised in outer layer 2 can further comprise the step of stirring the reaction mixture for a time sufficient to destroy completely any adventitious anhydride linkages, should any be present. The necessary stirring time will depend upon reactor configuration, stirrer geometry, stirring rate, temperature, total solvent volume, organic solvent volume, anhydride concentration, pH, and other factors. In some instances the necessary stirring time is essentially instantaneous, for example within seconds of pH adjustment to greater than 7, assuming any adventitious anhydride linkages were present to begin with. For typical laboratory scale reaction equipment a stirring time of greater than or equal to about 3 minutes, and in one embodiment, greater than or equal to about 5 minutes can be required. By this process nucleophiles, such as phenolic, phenoxide and/or hydroxide, can have time to destroy completely any anhydride linkages, should any be present.

Chain-stopper(s) (also referred to sometimes hereinafter as capping agent) can also be used in the interfacial method used to make the polymer comprising resorcinol arylate polyester chain members. A purpose of adding chain-stopper(s) is to limit the molecular weight of polymer comprising resorcinol arylate polyester chain members, thus providing polymer with controlled molecular weight and favorable processability. Typically, the chain-stopper(s) are added when the resorcinol arylate-containing polymer is not required to have reactive end-groups for further application. In the absence of chain-stopper resorcinol arylate-containing polymer can be either used in solution or recovered from solution for subsequent use such as in copolymer formation which can require the presence of reactive end-groups, typically hydroxy, on the resorcinol-arylate polyester segments. A chain-stopper can be mono-phenolic compound(s), mono-carboxylic acid chloride(s), mono-chloroformate(s), and combinations comprising at least one of the foregoing. Typically, the chain-stopper(s) can be present in quantities of 0.05 mole percent (mole %) to 10 mole %, based on resorcinol moieties in the case of mono-phenolic compounds and based on acid dichlorides in the case mono-carboxylic acid chlorides and/or mono-chloroformates.

Exemplary mono-phenolic compounds include monocyclic phenols, such as phenol, C₁-C₂₂ alkyl-substituted phenols, p-cumyl-phenol, p-tertiary-butyl phenol, hydroxy diphenyl; monoethers of diphenols, such as p-methoxyphenol. Alkyl-substituted phenols include those with branched chain alkyl substituents having 8 to 9 carbon atoms, in one embodiment, in which about 47% to about 89% of the hydrogen atoms are part of methyl groups. For some embodiments the use of a mono-phenolic UV screener as capping agent is preferred. Such compounds include 4-substituted-2-hydroxybenzophenones and their derivatives, aryl salicylates, monoesters of diphenols, such as resorcinol monobenzoate, 2-(2-hydroxyaryl)-benzotriazoles and their derivatives, 2-(2-hydroxyaryl)-1,3,5-triazines and their derivatives, and like compounds. In one embodiment the mono-phenolic chain-stopper(s) will be phenol, p-cumylphenol, resorcinol monobenzoate, or a combination comprising at least one of the foregoing.

Exemplary mono-carboxylic acid chlorides include monocyclic, mono-carboxylic acid chlorides, such as benzoyl chloride, C₁-C₂₂ alkyl-substituted benzoyl chloride, toluoyl chloride, halogen-substituted benzoyl chloride, bromobenzoyl chloride, cinnamoyl chloride, 4-nadimidobenzoyl chloride, and mixtures thereof; polycyclic, mono-carboxylic acid chlorides, such as trimellitic anhydride chloride, and naphthoyl chloride; and mixtures of monocyclic and polycyclic mono-carboxylic acid chlorides. The chlorides of aliphatic monocarboxylic acids with up to 22 carbon atoms, as well as functionalized chlorides of aliphatic monocarboxylic acids, such as acryloyl chloride and methacryoyl chloride, can also be used. Exemplary mono-chloroformates include monocyclic, mono-chloroformates, such as phenyl chloroformate, alkyl-substituted phenyl chloroformate, p-cumyl phenyl chloroformate, toluene chloroformate, and mixtures thereof.

A chain-stopper can be combined together with the resorcinol moieties, can be contained in the solution of dicarboxylic acid dichlorides, or can be added to the reaction mixture after production of a precondensate. If mono-carboxylic acid chlorides and/or mono-chloroformates are used as chain-stoppers, they can be introduced together with dicarboxylic acid dichlorides. These chain-stoppers can also be added to the reaction mixture at a moment when the chlorides of dicarboxylic acid have already reacted substantially or to completion. If phenolic compounds are used as chain-stoppers, they can be added to the reaction mixture during the reaction, or, more specifically, before the beginning of the reaction between resorcinol moiety and acid chloride moiety. When hydroxy-terminated resorcinol arylate-containing precondensate or oligomers are prepared, then chain-stopper can be absent or only present in small amounts to aid control of oligomer molecular weight.

In another embodiment the interfacial method used to provide the polymer comprising resorcinol arylate polyester chain members can encompass the inclusion of branching agent(s) such as a trifunctional or higher functional carboxylic acid chloride and/or trifunctional or higher functional phenol. Such branching agents, if included, can be used in quantities of 0.005 to 1 mole %, based on dicarboxylic acid dichlorides or resorcinol moieties used, respectively. Exemplary branching agents include, for example, trifunctional or higher carboxylic acid chlorides, such as trimesic acid trichloride, cyanuric acid trichloride, 3,3′,4,4′-benzophenone tetracarboxylic acid tetrachloride, 1,4,5,8-naphthalene tetracarboxylic acid tetrachloride or pyromellitic acid tetrachloride, and trifunctional or higher phenols, such as phloroglucinol, 4,6-dimethyl-2,4,6-tri-(4-hydroxyphenyl)-2-heptene, 4,6-dimethyl-2,4,6-tri-(4-hydroxyphenyl)-heptane, 1,3,5-tri-(4-hydroxyphenyl)-benzene, 1,1,1-tri-(4-hydroxyphenyl)-ethane, tri-(4-hydroxyphenyl)-phenyl methane, 2,2-bis-[4,4-bis-(4-hydroxyphenyl)-cyclohexyl]-propane, 2,4-bis-(4-hydroxyphenylisopropyl)-phenol, tetra-(4-hydroxyphenyl)-methane, 2,6-bis-(2-hydroxy-5-methylbenzyl)-4-methyl phenol, 2-(4-hydroxyphenyl)-2-(2,4-dihydroxyphenyl)-propane, tetra-(4-[4-hydroxyphenylisopropyl]-phenoxy)-methane, 1,4-bis-[(4,4-dihydroxytriphenyl)methyl]-benzene, and combinations comprising at least one of the foregoing. Phenolic branching agents can be introduced first with the resorcinol moieties whilst acid chloride branching agents can be introduced together with acid dichlorides.

In one exemplary embodiment, the polymer comprising the resorcinol arylate polyester chain members will be recovered from the interfacial reaction mixture by known recovery methods. Recovery methods can include such steps as acidification of the mixture, for example with phosphorous acid; subjecting the mixture to liquid-liquid phase separation; washing the organic phase with water and/or a dilute acid such as hydrochloric acid or phosphoric acid; precipitating by usual methods such as through treatment with water or anti-solvent precipitation with, for example, methanol, ethanol, and/or isopropanol; isolating the resulting precipitates; and drying to remove residual solvents.

If desired, the resorcinol arylate polymers used in the outer layer 2 can be made by the interfacial method further comprising the addition of a reducing agent. Exemplary reducing agents include, for example, sodium sulfite, sodium gluconate, or a borohydride, such as sodium borohydride. When present, any reducing agents are typically used in quantities of 0.25 mole % to 2 mole %, based on moles of resorcinol moiety.

In one embodiment, the polymers comprising resorcinol arylate polyester chain members will be substantially free of anhydride linkages linking at least two mers of the polyester chain. In a particular embodiment the polyesters comprise dicarboxylic acid residues derived from a mixture of iso-and terephthalic acids as illustrated in Formula VII:

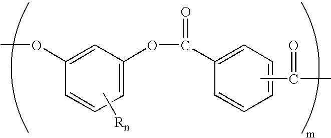

wherein R is C₁₋₁₂ alkyl(s) and/or halogen(s), n is 0-3, and m is at least about 8. In one embodiment, n is zero and m is about 10 to about 300. The molar ratio of isophthalate to terephthalate is (about 0.25 to about 4.0):1, in one embodiment (about 0.4 to about 2.5):1, and in another embodiment (about 0.67 to about 1.5):1. Substantially free of anhydride linkages means that the polyesters show decrease in molecular weight of less than or equal to about 30% and specifically, less than or equal to about 10% upon heating the polymer at a temperature of about 280° C. to about 290° C. for five minutes.

In one embodiment, the polymer comprising resorcinol arylate polyester chain members will comprise copolyesters comprising resorcinol arylate polyester chain members in combination with dicarboxylic acid or diol alkylene chain members (so-called “soft-block” segments), the copolyesters being substantially free of anhydride linkages in the polyester segments. Substantially free of anhydride linkages means that the copolyesters show decrease in molecular weight of less than or equal to about 10% and specifically less than or equal to about 5% upon heating the copolyester at a temperature of about 280° C. to about 290° C. for five minutes.

The term soft-block as used herein indicates that some segments of the polymers are made from non-aromatic monomer units. Such non-aromatic monomer units are generally aliphatic and are known to impart flexibility to the soft-block-containing polymers. The copolymers include those comprising structural units of Formulas I, VIII, and IX:

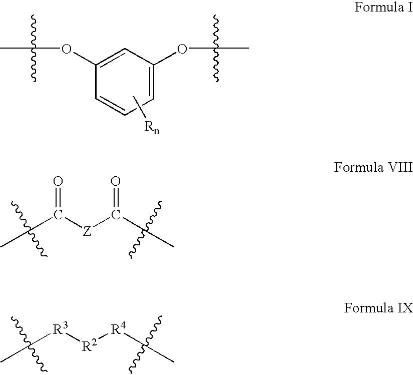

wherein R and n are as previously defined, Z is a divalent aromatic radical, R² is a C₃₋₂₀ straight chain alkylene, C₃₋₁₀ branched alkylene, or C₄₋₁₀ cyclo- or bicycloalkylene group, and R³ and R⁴ each independently represent

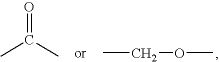

wherein Formula IX contributes from about 1 to about 45 mole percent to the ester linkages of the polyester. In other embodiments, Formula IX can contribute from about 5 to about 40 mole percent to the ester linkages of the polyester, with about 5 to about 20 mole percent being particularly preferred. Another embodiment provides a composition wherein R² represents C₃₋₁₄ straight chain alkylene, or C₅₋₆ cycloalkylene, with a preferred composition being one wherein R² represents C₃₋₁₀ straight-chain alkylene or C₆-cycloalkylene. Formula VIII represents an aromatic dicarboxylic acid residue. The divalent aromatic radical Z in Formula VIII can be derived from the dicarboxylic acid residue(s) as defined hereinabove, and specifically 1,3-phenylene, 1,4-phenylene, and/or 2,6-naphthylene. In some embodiments Z comprises greater than or equal to about 40 mole percent 1,3-phenylene. In one exemplary embodiment, for copolyesters containing soft-block chain members, n in Formula I is zero.

In one embodiment, the outer layer 2 will comprise copolyesters containing resorcinol arylate chain members comprising from about 1 to about 45 mole % sebacate or cyclohexane 1,4-dicarboxylate units. In another embodiment, the copolyester containing resorcinol arylate chain members is one comprising resorcinol isophthalate and resorcinol sebacate units in molar ratio of 8.5:1.5 to 9.5:0.5. In one exemplary embodiment, the copolyester is prepared using sebacoyl chloride in combination with isophthaloyl dichloride.

In another embodiment, the polymer comprising the resorcinol arylate polyester chain members will comprise thermally stable block copolyester carbonates comprising resorcinol arylate-containing block segments in combination with organic carbonate block segments. The segments comprising resorcinol arylate chain members in such copolymers are substantially free of anhydride linkages. Substantially free of anhydride linkages means that the copolyester carbonates show decrease in molecular weight of less than or equal to about 10% and less than or equal to about 5% upon heating the copolyester carbonate at a temperature of about 280° C. to about 290° C. for five minutes.

The block copolyester carbonates include those comprising alternating arylate and organic carbonate blocks, typically as illustrated in Formula X, wherein R and n are as previously defined, and R⁵ is divalent organic radical(s):

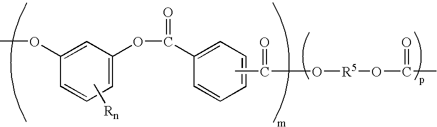

The arylate blocks have a degree of polymerization (DP), represented by m, of greater than or equal to about 4, specifically, greater than or equal to about 10, more specifically, greater than or equal to about 20 and most specifically, about 30 to about 150. The DP of the organic carbonate blocks, represented by p, is generally greater than or equal to about 10, specifically, greater than or equal to about 20, and more specifically, about 50 to about 200. The distribution of the blocks can be such as to provide a copolymer having any desired weight proportion of arylate blocks in relation to carbonate blocks. In general, the content of arylate blocks can be about 10 wt % to about 95 wt %, and specifically, about 50 wt % to 95 wt %, based upon the total weight of the arylate blocks.

Although a mixture of iso-and terephthalate is illustrated in Formula X, the dicarboxylic acid residues in the arylate blocks can be derived from any Exemplary dicarboxylic acid residue, as defined hereinabove, or mixture of Exemplary dicarboxylic acid residues, including those derived from aliphatic diacid dichlorides (so-called “soft-block” segments). In preferred embodiments n is zero and the arylate blocks comprise dicarboxylic acid residues derived from a mixture of iso- and terephthalic acid residues, wherein the molar ratio of isophthalate to terephthalate is (about 0.25 to about 4.0):1, specifically (about 0.4 to about 2.5):1, and more specifically (about 0.67 to about 1.5):1.

In the organic carbonate blocks, each R⁵ is independently a divalent organic radical. The radical can comprise dihydroxy-substituted aromatic hydrocarbon(s), and greater than or equal to about 60 percent of the total number of R⁵ groups in the polymer are aromatic organic radicals and the balance thereof are aliphatic, alicyclic, or aromatic radicals. Exemplary R⁵ radicals include m-phenylene, p-phenylene, 4,4′-biphenylene, 4,4′-bi(3,5-dimethyl)-phenylene, 2,2-bis(4-phenylene)propane, 6,6′-(3,3,3′,3′-tetramethyl-1,1′-spirobi[1H-indan]) and similar radicals such as those which correspond to the dihydroxy-substituted aromatic hydrocarbons disclosed by name or formula (generic or specific) as described U.S. Pat. No. 4,217,438.

In one exemplary embodiment, each R⁵ is an aromatic organic radical and still more specifically, a radical of Formula XI:

-A¹-Y-A²-

wherein each A¹ and A² is a monocyclic divalent aryl radical and Y is a bridging radical in which one or two carbon atoms separate A¹ and A². The free valence bonds in Formula XI are usually in the meta or para positions of A¹ and A² in relation to Y. Compounds in which R⁵ has Formula XI are bisphenols, and for the sake of brevity the term “bisphenol” is sometimes used herein to designate the dihydroxy-substituted aromatic hydrocarbons. It should be understood, however, that non-bisphenol compounds of this type might also be employed as appropriate.

In Formula XI, A¹ and A² typically represent unsubstituted phenylene or substituted derivatives thereof, illustrative substituents (one or more) being alkyl, alkenyl, and halogen (particularly bromine). Unsubstituted phenylene radicals are desirable. Both A¹ and A² can be p-phenylene, although both can be o- or m-phenylene or one o- or m-phenylene and the other p-phenylene.

The bridging radical, Y, is one in which one or two atoms separate A¹ from A². The preferred embodiment is one in which one atom separates A¹ from A². Illustrative radicals of this type arc —O—, —S—, —SO— or —SO₂—, methylene, cyclohexyl methylene, 2-[2.2.1]-bicycloheptyl methylene, ethylene, isopropylidene, neopentylidene, cyclohexylidene, cyclopentadecylidene, cyclododecylidene, adamantylidene, and like radicals. Gem-alkylene (commonly known as “alkylidene”) radicals are preferred. Also included, however, are unsaturated radicals. For reasons of availability and particular suitability for the purposes of this invention, the preferred bisphenol is 2,2-bis(4-hydroxyphenyl)propane (bisphenol-A or BPA), in which Y is isopropylidene and A¹ and A² are each p-phenylene. Depending upon the molar excess of resorcinol moiety present in the reaction mixture, R in the carbonate blocks can at least partially comprise resorcinol moiety. In other words, in some embodiments, carbonate blocks of Formula X can comprise a resorcinol moiety in combination with another dihydroxy-substituted aromatic hydrocarbon(s).

Polymers comprising resorcinol arylate polyester chain members further comprise diblock, triblock, and multiblock copolyestercarbonates. The chemical linkages between blocks comprising resorcinol arylate chain members and blocks comprising organic carbonate chain members can comprise (a) an ester linkage between a Exemplary dicarboxylic acid residue of an arylate moiety and an —O—R⁵—O— moiety of an organic carbonate moiety, for example as typically illustrated in Formula XII, wherein R is as previously defined:

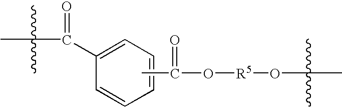

and/or (b) a carbonate linkage between a diphenol residue of a resorcinol arylate moiety and an organic carbonate moiety as shown in Formula XIII,

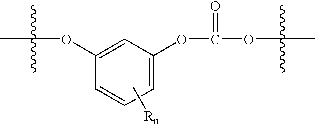

wherein R and n are as previously defined

The presence of a significant proportion of ester linkages of the type (a) can result in undesirable color formation in the copolyestercarbonates. Although the invention is not limited by theory, it is believed that color can arise, for example, when R⁵ in Formula XII is bisphenol A and the moiety of Formula XII undergoes Fries rearrangement during subsequent processing and/or light-exposure. In one embodiment the copolyester carbonate is substantially comprised of a diblock copolymer with a carbonate linkage between resorcinol arylate block and an organic carbonate block. In a more preferred embodiment the copolyester carbonate is substantially comprised of a triblock carbonate-ester-carbonate copolymer with carbonate linkages between the resorcinol arylate block and organic carbonate end-blocks.

Copolyestercarbonates with carbonate linkage(s) between a thermally stable resorcinol arylate block and an organic carbonate block are typically prepared from resorcinol arylate-containing oligomers and containing hydroxy-terminal site(s). The oligomers typically have weight average molecular weight (M_{w}) of about 10,000 to about 40,000, and specifically, about 15,000 to about 30,000. Thermally stable copolyestercarbonates can be prepared by reacting the resorcinol arylate-containing oligomers with phosgene, chain-stopper(s), and dihydroxy-substituted aromatic hydrocarbon(s) in the presence of a catalyst such as a tertiary amine.

In one exemplary embodiment, the polymer(s) comprising resorcinol arylate polyester chain members comprise an iso terephthalic resorcinol (ITR)/bisphenol A copolymer.

In one embodiment, the outer layer 2 can comprise sub-layer(s) wherein a sub-layer(s) comprises the polymer comprising resorcinol acrylate polyester chain members. In one embodiment, the outer layer 2 will consist solely of a single sub-layer comprising the polymer comprising resorcinol acrylate polyester chain members. In another embodiment, the outer layer 2 can comprise one or more additional sub-layers and in one exemplary embodiment, can comprise up to four additional sub-layers. For example, in one embodiment, a sub-layer can be a composition capable of adhering the outer layer 2 to the base layer 4. Illustrative examples of Exemplary adhesive compositions include heat sensitive adhesives, pressure sensitive adhesives, and the like.

In one particularly exemplary embodiment the outer-most layer of the outer layer 2 will be sub-layer(s) comprising a polymer comprising resorcinol acrylate polyester chain members. As used herein “outer-most layer” refers to the sub-layer(s) that form an exterior surface of outer layer 2 as illustrated in FIG. 1.

The outer layer 2 can comprise other components such as stabilizers, color stabilizers, heat stabilizers, light stabilizers, auxiliary UV screeners, auxiliary UV absorbers, flame retardants, anti-drip agents, flow aids, plasticizers, ester interchange inhibitors, antistatic agents, mold release agents, and colorants such as metal flakes, glass flakes and beads, ceramic particles, other polymer particles, dyes and pigments which can be organic, inorganic or organometallic, and combinations comprising at least one of the foregoing.

In one embodiment, the total thickness of the outer layer 2 is about 3 to about 25 thousands of an inch (hereafter “mil”). In another embodiment, the outer layer 2 is about 3 to about 15 mils thick. In one exemplary embodiment, the thickness of the outer layer 2 is about 5 to about 15 mils.

Turning now to the base layer 4, in one exemplary embodiment, the layer comprises a blend of aromatic polycarbonate and a copolymer derived from a glycol portion comprising 1,4 cyclohexanedimethanol and ethylene glycol and an acid portion comprising an aromatic dicarboxylic acid from the group consisting essentially of a terephthalic acid, a isophthalic acid, and mixtures of the foregoing acids. Exemplary base layer compositions are described in U.S. Pat. No. 4,786,692.

The aromatic polycarbonate component of the base layer 4 has recurring units of the formula:

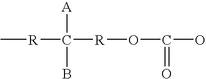

wherein each —R— is selected from the group consisting of phenylene, halo-substituted phenylene and alky-substituted phenylene and A and B are each selected from the group consisting of hydrogen, hydrocarbon radicals free from aliphatic unsaturation and radicals which together with the adjoining

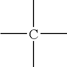

atom form a cycloalkane radical, the total number of carbon atoms in A and B being up to 12.

The polycarbonate can be a high molecular weight polymer having the formula:

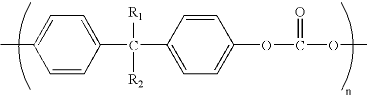

where R¹ and R² are hydrogen, (lower) alkyl or phenyl and n is greater than or equal to 30, and specifically, 40 to 400. The term “(lower) alkyl” includes hydrocarbon groups of from 1-6 carbon atoms.

High molecular weight, thermoplastic aromatic polycarbonates are to be understood as homopolycarbonates and copolycarbonates and combinations comprising at least one of the foregoing, which have a number average molecular weight of about 8,000 to more than 200,000, specifically, about 10,000 to about 80,000 and an intrinsic viscosity of 0.30 to 1.0 deciliters per gram (dl./g.) as measured in solution in methylene chloride at 25° C. The polycarbonates are derived from dihydric phenols such as, for example, 2,2-bis(4-hydroxyphenyl)propane, bis(4-hydroxyphenyl)methane, 2,2-bis(4-hydroxy-3-methylphenyl) propane, 4,4-bis(4-hydroxyphenyl)heptane, 2,2-(3,5,3′,5-tetrachloro-4,4′-dihydroxyphenyl)propane, 2,2-(3,5,3′5-tetrabromo-4,4′-dihydroxydiphenyl)propane, and (3,3′-dichloro-4,4′-dihydroxydiphenyl)propane, and (3,3′-dichloro-4,4′-dihydroxydiphenyl)methane. Other dihydric phenols for use in the preparation of the above polycarbonates are disclosed in U.S. Pat. Nos. 2,999,835; 3,028,365; 3,334,154 and 4,134,575.

The polycarbonates can be manufactured by known processes, such as, for example, by reacting a dihydric phenol with a carbonate precursor such as phosgene in accordance with methods set forth in U.S. Pat. Nos. 3,989,672; 4,018,750 and 4,123,436, or by transesterification processes such as are disclosed in U.S. Pat. No. 3,153,008, as well as others.

The aromatic polycarbonates utilized in base layer 4 also include the polymeric derivatives of a dihydric phenol, a dicarboxylic acid, and carbonic acid.

It is also possible to employ two or more different dihydric phenols or a copolymer of a dihydric phenol with a glycol or acid terminated polyester, or with a dibasic acid in the event a carbonate copolymer or interpolymer rather than a homopolymer is desired for use in the preparation of the aromatic polycarbonate. Also employable are blends of any of the above materials. Branched polycarbonates can be utilized, as can blends of a linear polycarbonate and a branched polycarbonate.

The polycarbonate resins can be derived from the reaction of bisphenol-A and phosgene. These polycarbonates have about 10 to about 400 recurring units of the formula:

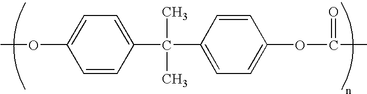

The polycarbonate should have an intrinsic viscosity of about 0.3 to about 1.0 dl./g, specifically, about 0.40 to about 0.65 dl./g as measured at 25° C. in methylene chloride or a similar solvent. Because of its ready availability, the ease with which it reacts with phosgene and the very satisfactory properties which it provides in polymerized form, bisphenol-A is preferred as the starting dihydric phenol compound. A Exemplary bisphenol-A polycarbonate is available under the trademark LEXAN® from General Electric Company.

The polyester copolymer component can, without limitation, comprise the reaction product of a glycol portion comprising 1,4-cyclohexanedimethanol and ethylene glycol, wherein the molar ratio of the 1,4-cyclohexanedimethanol to ethylene glycol in the glycol portion is from about 4:1 to 1:4, with an acid portion comprising terephthalic acid, isophthalic acid, and combinations comprising at least one of the foregoing.

The polyester copolymer component can be prepared by procedures such as by condensation reactions substantially as shown and described in U.S. Pat. No. 2,901,466. More particularly, the acid or mixture of acids or alkyl esters of the aromatic dicarboxylic acid or acids, for example dimethyltyerephthalate, together with the dihydric alcohols are charged to a flask and heated to temperatures sufficient to cause condensation of the copolymer to begin, for example to 175° C. to 225° C. Thereafter the temperature is raised to about 250° C. to 300° C., and a vacuum is applied and the condensation reaction is allowed to proceed until substantially complete.

The condensation reaction can be facilitated by the use of a catalyst, with the choice of catalyst being determined by the nature of the reactants. The various catalysts for use herein are known in the art and are too numerous to mention individually herein. Generally, however, when an alkyl ester of the dicarboxylic acid compound is employed, an ester interchange type of catalyst is preferred, such as NaHTi(OC₄ H₉)₆ in n-butanol. If a free acid is being reacted with the free glycols, a catalyst is generally not added until after the preliminary condensation has gotten under way.

The reaction is generally begun in the presence of an excess of glycols and initially involves heating to a temperature sufficient to cause a preliminary condensation followed by the evaporation of excess glycol. The entire reaction is conducted with agitation under an inert atmosphere. The temperature can then be advantageously increased with or without the immediate application of a vacuum. As the temperature is further increased, the pressure can be advantageously greatly reduced and the condensation allowed to proceed until the desired degree of polymerization is achieved. The product can be considered finished at this stage or it can be subjected to further polymerization in the solid phase in accordance with well-known techniques. Thus, the highly monomeric condensation product produced can be cooled, pulverized, and the powder heated to a temperature somewhat less than that employed during the last stage of the molten phase polymerization thereby avoiding coagulation of the solid particles. The solid phase polymerization is conducted until the desired degree of polymerization is achieved. The solid phase polymerization, among other things, results in a higher degree of polymerization without the accompanying degradation which frequently takes place when continuing the last stage of the melt polymerization at a temperature high enough to achieve the desired degree of polymerization. The solid phase process is advantageously conducted with agitation employing an inert atmosphere at either normal atmospheric pressure or under a greatly reduced pressure.

Copolyesters used herein as the copolymer for base layer 4 generally will have an internal viscosity of at least about 0.4 dl./gm as measured in 60/40 phenol/tetrachloroethane or other similar solvent at about 25° C. and will have a heat distortion temperature of about 60° C. to 70° C. The relative amounts of the 1,4-cyclohexanedimethanol to ethylene glycol in the glycol portion can vary so long as the molar ratio of 1,4-cyclohexanedimethanol to ethylene glycol is about 1:4 to about 4:1, in order to provide a polyester copolymer having Exemplary properties and a heat distortion temperature within the recited range.

A preferred copolymer for use is a copolyester as described above wherein the glycol portion has a predominance of 1,4-cyclohexanedimethanol over ethylene glycol, e.g., greater than or equal to a 50/50 mixture, and specifically is about 65 molar 1,4-cyclohexanedimethanol to 35 molar ethylene glycol and the acid portion is terephthalic acid. When this copolyester is blended with bisphenol-A polycarbonate, the resultant blends are generally completely miscible over a broad range of the components, exhibit a single glass transition temperature indicating the formation of a single phase blend and exhibit tranluncies of greater than or equal to 80%. These blends show significant reduction in heat distortion temperature over polycarbonate and in addition retain very high flexural and tensile strength.

Another copolyester for use as the copolymer in base layer 4 is a copolyester as described above wherein the glycol portion has a predominance of ethylene glycol over 1,4-cyclohexanedimethanol, for example greater than 50/50 and specifically is about 70 molar ethylene glycol to 30 molar 1,4-cyclohexanedimethanol and the acid portion is terephthalic acid. When this copolyester is blended with bisphenol-A polycarbonate over broad ranges of the components, compatible two-phase blends are formed which exhibit two glass transition temperatures. These blends likewise display a reduced heat distortion temperature over polycarbonate and also retain high tensile and flexural strength and properties.

The base layer 4 thermoplastic compositions can comprise about 98 wt % to about 2 wt % of aromatic carbonate polymer or copolymer and about 2 wt % to about 98 wt % of polyester copolymer component, based upon the weight of the overall composition. The improved characteristics of these compositions are exhibited over a wide range of the components. In those composition described above exhibiting two phases, i.e. those wherein the glycol portion of copolyester component is predominantly ethylene glycol over 1,4-cyclohexanedimethanol, the compositions are generally semi-transparent to opaque.

Each of the above-described base layer 4 compositions display good tensile and flexural strengths and reduced glass transition and heat distortion temperatures over polycarbonates or polycarbonate/polyethylene terephthalate blends.

The base layer 4 can further include an impact modifying agent. Some exemplary impact modifiers include hydrogenated linear radial or teleblock copolymer of vinyl aromatic compounds (A) and (A′).sub.n and an olefinic elastomer (B) of the A-BA′; A-(BAB)ₙ-A; A(BA)ₙ B; (A)₄ B; B(A)₄; or B((AB)ₙ B)₄ type, wherein n is an integer from 1 to 10. Typically, the vinyl aromatic compounds A and A′ are selected from styrene, alpha-methylstyrene, vinyl toluene, vinyl xylene, vinyl napthalene and especially styrene. The olefinic elastomer B is usually derived from butadiene, isoprene, 1,3-pentadiene 2,3-dimethylbutadiene and the like and can have a linear, sequential or teleradial structure. Another useful impact modifying agent for use in the base layer compositions are the various polyacrylate resins known in the art. For example, Exemplary polyacrylates can be made in known ways, but are abundantly commercially available from many sources. Polyalkyl acrylates, especially those containing units derived from n-butyl acrylate can be used. The polyacrylate can comprise a multiple stage polymer having a rubbery first stage and a thermoplastic hard final stage. The impact modifiers can be added to the base layer composition in conventional amounts of about 0.01 wt % to about 50 wt % based on the weight of the overall composition and usually in amounts of about 0.01 wt % to about 10 wt % by weight on the same basis.

In many applications for the multilayer article 20 it can be desirable that they be substantially flame retardant. Known flame retardant agents can be added to the base layer 4 to accomplish this purpose, and generally the useful flame retardant agents comprise compounds containing bromine, chlorine, antimony, nitrogen and combinations comprising at least one of the foregoing. More particularly, the flame retardant additive comprises a halogenated organic compound (brominated or chlorinated); a halogen-containing organic compound in admixture with an organic or inorganic antimony compound, e.g., antimony oxide, and combinations comprising at least one of the foregoing. Particularly useful flame retardant additives are the copolycarbonates which are the product of a halogenated bisphenol-A and a dihydric phenol, such as a tetrabromobisphenol-A/bisphenol-A copolycarbonate.

Illustrative of the halogen-containing compounds include the chlorinated and/or brominated aromatics and diaromatics such as disclosed in U.S. Pat. No. 4,020,124, including: 2,2-bis(3,5-dichlorophenyl)propane, bis(2,6-dibromophenyl)methane, tetrabromobenzene, hexachlorobenzene, hexabromobenzene, decabromobiphenyl, etc, and combinations comprising at least one of the foregoing. Also encompassed are the phthalimide flame retardants, for example, those derived from alkanes such as methane, ethane, propane, butane and the like, containing one, two or more halogenated phthalimide groups, and specifically a dipthalimide.

Synergistic agents can also be added in amounts generally less than three parts by weight of the overall composition, with special mention being made of antimony oxide.

The base layer 4 can, as has already been mentioned, also include other additives. For example, pigments, such as titanium dioxide, and foaming agents, such as 5-phenyltetrazole, can be added. The compositions the invention can be reinforced with reinforcing amounts of reinforcing agents, such as powders, whiskers, fibers or platelets of metals, e.g., aluminum, bronze, iron or nickel, and nonmetals, e.g., carbon filaments, acicular CaSiO₃, asbestos, TiO₂ titanate whiskers, glass flakes, glass fibers, and the like, as well as combinations comprising at least one of the foregoing. Such reinforcements need only be present in reinforcing amounts and generally 1 parts by weight (pbw) to 60 pbw, specifically, about 5 pbw to about 40 pbw, of the total composition will comprise reinforcing agent. The compositions can also contain stabilizers, such as phosphites, phosphates, epoxides, and the like, either individually or in combination, depending on the end use. It has been discovered that although high temperatures are not required for processing the compositions of the subject invention, in instances where high mixing, extrusion or molding temperatures are employed or desired, for example temperatures above 575° F. (301.7° C.), some discoloration and therefore degradation can occur, which can be substantially reduced by inclusion of a stabilizer such as phosphite stabilizer(s).

The thickness of the base layer 4 is determined by the desired application. In one embodiment, base layer 4 is about 2 mils to about 200 mils thick, while in another embodiment, the base layer 4 is about 10 to about 100 mils thick. In one exemplary embodiment, the base layer 4 will be about 30 to about 50 mils thick.

Generally, the total thickness of the thermoplastic multilayer film is about 20 to about 200 mils. In one exemplary embodiment, the thermoplastic multilayer film 10 is about 40 to about 60 mils thick.

The thermoplastic multilayer film can be made by any of a variety of manufacturing methods including co-injecting molding, co-extrusion lamination, co-extrusion blow film molding, co-extrusion, overmolding, multi-shot injection molding, sheet molding, and the like, as well as combinations comprising at least one of the foregoing. In one embodiment, the multi-layer laminate can be made by co-extrusion lamination. In another embodiment, the outer layer 2 can be laminated on separately, from a prior extruded film put on a roll. In such an embodiment, the outer layer 2 can comprise sub-layer(s) that comprises an adhesive or adherent composition.

In one embodiment, the multi-layer laminate 10 is prepared by co-extrusion lamination wherein the layers are simultaneously extruded through a sheet or film die orifice that can be of a single manifold or multi-manifold design. While still in the molten state, the layers are laminated together and then compressed together by being passed through the nip of a pair of rolls that can be heated. The laminate is then cooled. The thickness of the multi-layer laminate 10 is determined by the desired application.

In another embodiment, the thermoplastic multilayer film 10 is formed by co-extrusion wherein the individual molten layers 2 and 4 are injected together and extruded through a die orifice thereby extruding a multilayer sheet or film and then cooled.

In yet another embodiment, a process to form the thermoplastic multilayer film 10 involves the co-extrusion blow film process wherein multilayers are extruded to form a tubular parison that is then blow molded into a hollow article that is subsequently slit to prepare a flat thermoplastic multilayer film 10.

Moreover, in an exemplary embodiment, the outer layer and base layer of the multilayer film will be miscible when mixed together. Miscibility between the resins of the disclosed multilayer film provides the opportunity to increase yield gains by recycling scrap film produced during production runs. The term “scrap” as used herein is intended to generally mean extruded multilayer film material lost, e.g., through any of the following ways such as trim losses, start-up losses, contamination lows, raw material quality issue losses, process upset losses, mechanical failures on the line, and the like, all of which contribute to the amount of scrap generated during production of the outer layer and base layer film. Because the outer layer and base layer of the film are miscible, this scrap can be reground, i.e., repelletized, to give a single homogeneous blend, which can be recycled back into the line, and mixed with the virgin resin. As will be described in more detail below in the Example section, less than or equal to about 40 wt % of the base layer can comprise recycled (i.e. scrap) film generated in previous production runs, or, specifically, about 1 wt % to about 20 wt %, or, more specifically, about 5 wt % to about 20 wt %, or, yet more specifically, about 10 wt % to about 20 wt %, and even more specifically, about 10 wt % to about 15 wt %, based upon a total weight of the total weight of the mixture of the recycle materials and the virgin base layer.

Turning now to FIG. 2, an article 20 is shown wherein the base layer 4 provides desirable adhesion between the thermoplastic multilayer film 10 and a substrate 6. The base layer 4 is adhered to the substrate 6 while simultaneously providing good adhesion to the outer layer 2 of the thermoplastic multilayer film 10.

The substrate 6 employed can be any of a variety of Exemplary compositions including but not limited to thermoset materials, thermoplastic materials, foamed materials, reinforced materials, and combinations comprising at least one of the foregoing. Illustrative examples include polyurethane compositions (including polyurethane foam and fiber reinforced polyurethane), polycarbonate (PC) blends (e.g., PC/PBT (polybutylene terapthalate) blends, PC/ASA (acrylonitrile styrene acrylonitrile) blends, PC/ABS (acrylonitrile butadiene styrene) blends, and the like), and the like, as well as combinations comprising at least one of the foregoing. Reinforcing fibers include carbon, glass, and the like.

In one embodiment, the substrate 6 will be reinforced thermoplastic polyurethane(s), foamed thermoplastic polyurethane(s), and combinations comprising at least one of the foregoing. In one exemplary embodiment, the substrate 6 will be glass fiber-reinforced polyurethane(s), carbon fiber-reinforced polyurethane(s), foamed thermoplastic polyurethane(s), and combinations comprising at least one of the foregoing.

The bonding of base layer 4 to substrate 6 can result from injection molding, reaction injection molding, adhesives, chemical bonding, mechanical bonding, and the like, as well as combinations comprising at least one of the foregoing. In one exemplary embodiment, the bonding of the base layer 4 to substrate 6 will result from the injection molding of a substrate 6 directly onto the base layer 4.

In one method of applying the substrate 6 to the multilayer laminate 10, a long-fiber injected polyurethane is backmolded, i.e., backfoamed behind the base layer 4 through a reaction injection molding (RIM) process. A schematic of the process 50 is shown in FIG. 3. RIM is essentially a process for synthesizing cellular or expanded materials such as polyurethane foams, by the reaction of isocyanate (IC) with polyol (OL) in the presence of a blowing agent. Other components added in the reaction mixture determine the mechanical properties of the foam (e.g., rigid or soft). These additional components, such as branching agents/chain extenders, catalysts, surfactants, fillers, pigments, dyes, and the like, are formulated into the primary reaction components; IC or OL. The two liquid components, IC and OL, are held in separate, temperature-controlled feed tanks 52, 54 equipped with agitators 56, 58. From these tanks, the IC and OL feed through supply lines 60, 62, all maintained at about 25 to about 30 degrees Celsius (° C.), to metering units 64, 66 that precisely meter both components, at about 3,000 pounds per square inch (psi) pressure, to a mix-head device 68, where the components are mixed by high-velocity impingement. Initial viscosities of the IC and the OL are about 120 millipascal seconds (mPa·s) and about 3,300 pascal seconds (Pa·s) respectively.

When injection of the liquids into the mold 70 is to begin, valves in the mix-head open and the liquid IC-OL mixture is sprayed over the mold 70 in a random pattern. A glass chopper (not shown) attached to the mix-head simultaneously sprays about 12 millimeter (mm) to about 15 mm long, glass fibers. This discharge from the mix-head chamber occurs at atmospheric pressure. The spray cycle lasts for about 30 to about 45 seconds, after which the mold 70 is closed. The mold 70 is maintained at a constant temperature of about 50° C. to about 70° C. The mold acts as a heat source in the beginning of the cycle by raising the reaction mixture temperature in order to start the reaction. Toward the end of the reaction, the mixture temperature increases above the mold temperature to about 120° C., and the mold 70 helps to cool the mixture. The size of the mold can vary depending on desired substrate and/or article specifications.

Inside the mold, the liquid mixture undergoes a highly exothermic chemical reaction, which starts (e.g., about 40 seconds) after the reactants (IC and OL) are mixed. The formation of the foam goes through following four stages. The first stage is the latent stage, and is the 40 second period mentioned above. During this stage, the evolving blowing gas dissolves in the reactant mixture until saturation. Once gas saturation has been achieved, micronuclei of bubbles emerge and the mixture starts to look like a cream and begins increasing in volume. The second stage is the foam growth stage, which begins with a visible increase in volume of the reactant mixture and ends when the mixture attains the highest possible volume. The third stage is the foam stabilization stage, which corresponds to a stage of increasing mixture viscosity. The liquid components of the reactant mixture turn into a solid polymer. Finally, there is the maturation or curing stage, in which the foam becomes cross-linked and acquires a strength suitable for the article's 20 application.

The isocyanates are major components of polyurethane foam. They can be aliphatic, like hexamethylene diisocyanate (HDI), isophorone diisocyanate (IPDI), or aromatic, like toluene diisocyanate (TDI), 4,4/-diphenylmethane diisocyanate (MDI), and naphthalene diisocyanate (NDI), and combinations comprising at least one of the foregoing. TDI is used for soft polyurethane foams, whereas rigid foams, such as for exemplary use in the articles and applications described herein are made from pre-polymer based on MDI.

The polyols can be either polyether, such as propylene glycol (PG) and trimethylolpropane (TMP) combined with sucrose, or polyester, such as ethylene glycol, 1,2-propanediol, 1,4-butanediol, and diethylene glycol combined with glycerol. Polyethers are used to produce the flexible and rigid foams as used with the articles as described herein, and polyesters are used to produce elastomers, flexible foams, and coatings.

Chain extending agents are the diols and diamines of small molar mass, and they increase the size of the rigid segments and the relative molar mass (RMM) of the polyurethane foam. The corresponding multi-functional compounds act as branching or cross-linking agents. Common chain extenders are ethylene glycol, diethylene glycol, propylene glycol, dipropylene glycol, 1,4-butandiol, 1,4-cyclohexandiol, hexamethylenediamine, hydrazine, and the like.

The blowing agent for the polyurethane foams described herein can be water. In another embodiment, low boiling inert solvents can be used. Water reacts with the isocyanate groups to produce carbon dioxide, which acts as the foaming agent.

Surfactants allow reduction of the bubble size and control the structure and enhancement of the polyurethane foam. The polyurethane foam used herein can be manufactured using non-ionic organosilicon-polyether copolymer.

The catalysts control the foaming and curing rates and enable manufacture of polyurethane foam at an economical rate. The isocyanate reaction catalysts are divided into two major groups: tertiary amines and organometallic compounds, especially tin derivatives.

Fillers can also be used in polyurethane foams and can be classified as particulate, flaky and fibrous fillers. The particulate fillers increase the density and hardness of the polyurethane foams. Fibrous fillers, such as those used polyurethane foams as described herein, are used to increase the rigidity and elastic modulus of the foam.

The multilayer articles disclosed herein typically have outstanding initial gloss, improved initial color, weatherability, impact strength, and resistance to organic solvents encountered in their final applications. Generally, the surface of the multilayer article has an aesthetically pleasing exterior surface. The automotive industry describes the desired exterior surface as an exterior class-A surface finish. The articles can also be recyclable by reason of the compatibility of the discrete layers therein.

Multilayer articles as disclosed herein also include those comprising glass layer(s) as a supplemental layer. The glass layer can be contiguous to the top layer, contiguous to the substrate layer, or interposed between a top layer and a substrate layer. Depending upon the nature of the glass layer and the layer to which it is contiguous, adhesive interlayer(s) can be beneficially employed between any glass layer and any top layer or substrate layer. The adhesive interlayer can be transparent, opaque or translucent. For many applications, the interlayer is optically transparent in nature and generally have a transmission of greater than about 60% and a haze value less than about 3% with no objectionable color. Wherein haze is measured in accordance with ASTM D-1003-00, Procedure A, measured, e.g., using a HAZE-GUARD DUAL from BYK-Gardner, using and integrating sphere (0%/diffuse geometry), wherein the spectral sensitivity conforms to the CIE standard spectral value under standard lamp D65.

The multilayer articles as described herein can advantageously be employed in applications where durability, weatherability, weight, and appearance are important considerations. In an exemplary embodiment, the multilayer articles can be employed for vehicle applications, such as, without limitation, automotive vehicles including cars, trucks, vans, motorcycles, and the like, aircraft, marine craft, including boats, personal watercraft, and the like, and recreational vehicles, including motor homes, all-terrain vehicles, snowmobiles, and the like. Components on such vehicle applications can be made from the multilayer articles comprising the thermoplastic multilayer films as disclosed herein. Examples of such components include, without limitation, body panels, trim, fenders, doors, decklids, trunklids, hoods, grilles, mirror housings, pillar appliques, body side moldings, wheel covers, spoilers, roof racks, hulls, housings, and other like vehicle components.

The multilayer thermoplastic films and articles as disclosed herein have superior adhesion properties between the multilayer films and the foam substrates over current multilayer thermoplastic articles. Moreover, the outer layer and the base layer of the multilayer laminate are miscible when recycled and mixed together.

The following examples, which are meant to be exemplary, not limiting, illustrate the improved adhesion and recyclability of the multilayer thermoplastic films described herein.

### EXAMPLES

### Example 1

### Adhesion Properties

Fourteen multilayer laminates having a thickness of 50 mil (1.27 millimeters (mm)) were backmolded with polyurethane foam substrates. Each laminate was made of an outer layer of an iso terephthalic resorcinol/bisphenol A copolymer, commercially available from GE Plastics as ML9577, and a base layer of a blend of aromatic polycarbonate and a copolymer derived from a glycol portion comprising 1,4 cyclohexanedimethanol and ethylene glycol and an acid portion comprising an aromatic dicarboxylic acid selected from the group consisting essentially of terphthalic acid, isophthalic acid, and mixtures of the two. The base layer is commercially available from GE Plastics as XYLEX®. The outer layer had a thickness of 10 mil (0.25 mm), and the base layer 40 mil (1.02 mm) to produce a multilayer laminate having a 50 mil (1.27 mm) thickness.

A long-fiber injected polyurethane foam substrate was backmolded to the multilayer laminates under the following conditions. Polyols and an isocyanate were mixed and reacted together by the process detailed above. The polyol used is commercially available from Bayer as BAYDUR® 71IF20, and the isocyanate is commercially available from Bayer as DESMDUR® 78IF02. The volume mixing ratio of polyol to isocyanate was 100:185. Glass fibers were sprayed into the mold simultaneously with the polyol-isocyanate mixture such that a glass fiber concentration of 20 volume percent resulted. The mixture was sprayed into a mold at a temperature of about 70° C. for about 30 to about 45 seconds. The mixture was then held in the mold for about 240 seconds and the reaction temperature was maintained at about 25° C.

Fourteen plaques were then generated from the multilayer articles. Each test specimen had a size of 1 inch (2.54 centimeters (cm) by 9 inches (22.9 cm) and was cut out of the molded plaques such that the free end of the test specimen lied along the mold edge.

The average value of adhesion (shown in pounds force per inch (lb_{f}/in), as averaged over five positions on each molded plaque, is illustrated in FIG. 4 and the value reproduced below in Table 1. Furthermore, FIG. 5 illustrates an Instron plot showing the peel strength (lb_{f}/in) versus the extent of peel in inches (in) for four samples. The peel strength herein was determined using a 90 degree peel test in accordance with ASTM D-3167-03a (1973), unless specifically set forth otherwise.

TABLE 1
Average Adhesion

| Peel Strength (lb_{f}/in) | | Peel Strength (lb_{f}/in) | |
|---|---|---|---|
| Sample | 200 hours after molding | Sample | 480 hours after molding |
| 1 | 1.15 | 9 | 6.8 |
| 2 | 1.86 | 10 | 8.9 |
| 3 | 4.2 | 11 | 6.7 |
| 4 | 4.7 | 12 | 4.7 |
| 5 | 4.7 | 13 | 7.0 |
| 6 | 3.3 | 14 | 7.8 |
| 7 | 4.6 | | |
| 8 | 4.6 | | |

As can be seen from Table 1 and FIG. 4, despite similar processing conditions, the measured adhesion varies distinctly from sample to sample. The adhesion is higher for the samples tested later. Samples 1-8 were tested 200 hours after backmolding, stored at room temperature. These samples had an average of 3.68 pounds per linear inch (pli). The samples 9-14, however, were tested 480 hours after backmolding and averaged a peel strength of 6.98 pli.

FIG. 5 further illustrates that the adhesion in the last two inches of the test samples are an average of 20 percent higher than the remainder of the test strips. The direction of peel is from the mold edge toward the mold center. FIG. 6 shows an example of one molded plaque 100 and the orientation of a test sample 110 cut out to measure adhesion. Since the mold edges experience more heat dissipation than the mold center, the mold center retains more of the exothermic heat generated during the reaction. The Instron plot indicates that there can exist a radial temperature gradient within the mold and that adhesion is improved with higher temperatures.

To further investigate the temperature-time effect on adhesion properties of the multilayer laminates to the polyurethane substrates, 3 sets of samples were subjected to various conditioning and tested for adhesion strength, as shown in Table 2 below.

TABLE 2
Sample Conditioning for Adhesion Strength Testing

Conditioning

| Sample Set | Temperature (° C.) | Time (min) |
|---|---|---|
| 1 | 65 | 15 |
| 2 | 90 | 15 |
| 3 | 90 | 30 |

Adhesion was then measured and compared to the adhesion values for the representative samples before conditioning. The results are illustrated in the Instron plots of FIG. 7. For sample set 1, upon exposure to 65° C. for 15 minutes, the adhesion over the first few inches of the test strips remained unchanged over the unconditioned specimen. Adhesion near the end of the test strips, however, increased by a factor of four before the film tore away from the substrate. To reiterate, this section of the test strips lies nearest the mold center. In sample set 2, after exposure of 90° C. for 15 minutes, a four fold increase in adhesion is seen at the start of the test strip. This further indicates the improved adhesion characteristics for the film when exposed to higher temperatures. For sample set 3, which was exposed to 90° C. for 30 minutes, it was not possible to delaminate any of the test specimens. FIG. 8 reports the average adhesion values with 1 sigma error bars for each of the three sample sets. The samples labeled “0-0”, are the adhesion values for that sample prior to conditioning.

In comparison to a 3 layer article, the 2 layer article has unexpectedly improved adhesion. The 3-layer article comprised the same outer layer as the 2 layer article, namely a 10 mil (0.25 mm) iso terephthalic resorcinol/bisphenol A copolymer (ML 9577 commercially available from GE Plastics), a 30 mil (0.76 mm) polycarbonate (PC) middle layer (ML9654 commercially available from GE Plastics), and a 10 mil (0.25 mm) bottom layer comprising a PC/ABS blend (Product CE 8510 commercially available from GE Plastics). The two layer article comprises the same outer layer and, instead of the middle and bottom layers, had a 40 mil (1.02 mm) base layer comprising a blend of 75 wt % PC and 25 wt % PCTG (i.e., the copolymer derived from a glycol portion comprising 1,4 cyclohexanedimethanol and ethylene glycol wherein the molar ratio of 1,4 cyclohexanedimethanol to ethylene glycol is 4:1, and an acid portion comprising an aromatic dicarboxylic acid). These multilayer samples were backmolded to a polyurethane substrate as is set forth in Example 1. The dramatic increase in adhesion with time in the 2-layer design vs. the 3-layer is shown in the Table 3.

TABLE 3
Peel Strength

| | Adhesion in 3-layer | Adhesion in 2-layer |
|---|---|---|
| Duration | (lbf/in) | (lbf/in) |
| 2 days | 2.7 | 1.9 |
| 20 days | 5.8 | 7.0 |
| 40 days | 6.5 | 13.6 |
| 1 yr | 7.1 | Inseparable |

As seen from the experimental data above, the thermoplastic multilayer articles as disclosed herein have adhesion strengths between the base layer and the substrate that unexpectedly, yet advantageously increase as a function of time to an unexpected degree. In the above test, while the three layer article had adhesions that pealed at less than 8 lb/in, the present 2 layer article, adhesions of greater than or equal to 10 lb/in, or specifically, greater than or equal to about 15 lb/in, or, more specifically, even greater adhesions that were not measurable with the current equipment as no delamination was attained.

### Example 2

### Recyclability

The thermodynamic miscibility between the two resins, the resorcinol arylate polyesters of the outer layer and the polyester copolymer and polycarbonate components of the base layer, was analyzed based on haze measurements. The outer layer comprises resorcinol and is commercially available from GE Plastics, Pittsfield, Mass., under grade ML9577. The base layer is the same as defined in Example 1. FIG. 9 is a ternary diagram, which illustrates that the mapped phase space of the two layers suggests significant miscibility based on haze measurements. On the diagram, “A” is the outer layer, namely ML9577, “B” is polycarbonate, Lexan®, namely ML 9735, and “C” is PCTG, i.e., a polymer derived from a glycol portion and an acid portion, wherein the glycol portion comprises 1,4 cyclohexanedimethanol and ethylene glycol wherein the molar ratio of 1,4 cyclohexanedimethanol to ethylene glycol ratio is 4:1, and the acid portion comprises an aromatic dicarboxylic acid selected from the group consisting essentially of terphthalic acid, isophthalic acid, and combinations comprising at least one of the foregoing acids

For a thermoplastic multilayer film having a 10:40 proportion of outer layer to base layer, i.e., a 10 mil (0.25 mm) layer of outer layer to a 40 mil (1.02 mm) of base layer, FIG. 9 suggests miscibility of up to 40 percent recycle. In other words, a blend of 60% virgin base layer material and 40% film (which contains approximately 20% outer layer material and 80% base layer material) would be miscible. ASTM D-1003-00, Procedure A, measured, e.g., using a HAZE-GUARD DUAL from BYK-Gardner, using and integrating sphere (0%/diffuse geometry), wherein the spectral sensitivity conforms to the CIE standard spectral value under standard lamp D65.

Further experimentation was done to determine the effects of recycling the multilayer laminate on the properties of the new film. A compounding experiment was conducted to simulate the effects of regrind proportion (i.e., recycled base layer material) and heat histories on the multilayer films. The recycling scheme envisioned for the experiment proposes the regrind be fed into the base layer only, leaving the outer layer virgin alone. Hence, the only concern for the experiment was property changes in the base layer resin. The simulated recycling scheme or flow of resin for the experiment was film extrusion to repelletization with the regrind in multiple proportions, followed by another film extrusion. All the formulations in Samples 0 through 8 were compounded on a single screw extruder. The sample formulations were compounded to simulate the flow of the base layer resin through the process chain, picking up heat histories and regrind as the base layer resin goes through compounding, film extrusion, and recompounding processes.

First the rheological properties of the samples were analyzed. FIG. 10 is a viscosity baseline using virgin base layer resin. The figure illustrates the drop in viscosity of the virgin resin with each successive heat history. As used herein, the term ‘heat history’ is intended to mean the number of times the sample has gone through an extrusion process (e.g. compounding, extrusion, recompounding) cycle. A drop in initial viscosity of 10% after 3 heat histories, and of 16% after 5 heat histories was seen for the virgin resin. The viscosity drop for various recycled sample formulations was then measured for comparison. The sample formulations and their respective initial viscosities and melt volume rates (MVR) can be seen in Table 4 below.

TABLE 4

| | Regrind | | Initial | MVR |
|---|---|---|---|---|
| | Composition | | Viscosity | (266° C./2.16 kg, |
| Sample | (%) | Heat Histories | (Pa · s) | 10 min) |
| 0 | 0 (Virgin base) | 1 | 12,000 | 7.27 |
| 1 | 10 | 1 | 10,300 | 6.71 |
| 2 | 20 | 1 | 10,900 | 6.96 |
| 3 | 30 | 1 | 10,500 | 7.33 |
| 4 | 40 | 1 | 10,300 | 6.98 |
| 5 | 10 | 2 | 10,800 | 6.73 |
| 6 | 20 | 2 | 11,000 | 6.88 |
| 7 | 30 | 2 | 10,700 | 6.98 |
| 8 | 40 | 2 | 10,400 | 5.95 |

Comparative graphs of the initial viscosity and MVR variation with composition and extrusion passes can be seen in FIGS. 11 and 12, respectively. While there is no discernable trend in the viscosity drops across the various recycled formulations, there is about a 10% drop in viscosity for each formulation when compared to the virgin sample (Sample 0). This viscosity drop is consistent with the drop that occurred in the virgin base layer resin after an equivalent number of heat histories (as shown in FIG. 10). The reason for this insignificant change is the similar viscosities of both the outer layer and base layer. The reason for the negligible change seen between the first and second passes, i.e., the samples with 1 versus 2 heat histories in FIG. 11, is that only a small proportion of the formulation goes through the additional heat history. The virgin base layer resin, which constitutes the majority of all these formulations, goes through the same number of heat histories in the sample formulations having one heat history (Samples 1-4) and the sample formulations having two (Samples 5-8).

Moreover, the MVR, as shown in FIG. 12, was measured in grams per cubic centimeter in 10 minutes at 266° C., 2.16 kilograms, and shows variation within 7% across all samples, which falls within the standard deviation of the measurement. Similar to the initial viscosities, no trend is seen here either. The above measurements and representative graphs suggest there is no appreciable breakdown of the multilayer resin as it goes through multiple extrusion heat cycles.

In addition, while the initial viscosity exhibited negligible change, equally important is the stability of the resin and retention of its rheological properties under shear stress, i.e., during extrusion. The ability of the resin to retain its rheological properties under shear stresses determines the resin's processability. FIG. 13 illustrates the time sweep data at 10 hertz (Hz) frequency and 275° C. The time sweep response for the regrind formulations (samples 0-8) reveals a less than 6% viscosity drop over 15 minutes for all samples. Moreover, the viscosity change is similar across each formulation, about less than 8% in 10 minutes, which is the residence time of the single screw extruder used in the experiment. The consistent and minimal viscosity drop for all formulations indicates that the recycled multilayer film content does not markedly impact the stability of the base layer resin.

FIG. 14 further emphasizes the thermal stability of all the sample formulations through a thermogravimetric analysis (TGA) in the processing temperature of about 40° C. to about 800° C. FIG. 14 illustrates the weight-loss profiles and the onset temperature of weight loss for the various sample formulations. In addition Sample 0 (virgin resin with only one heat history), additional virgin samples were tested, each having undergone another heat cycle. The subscripts indicate the number of heat histories (e.g. Sample 0₃ has three heat histories). The weight-loss profiles are similar for each of the sample formulations, starting within a temperature about plus or minus 2° C. of 414° C., and averaging 86% plus or minus 1% weight-loss over that temperature range. There are negligible thermal stability variations, therefore, between the sample formulations having various recycle compositions and heat histories.

Mechanical properties for the various sample formulations were also tested. The percent ductility and impact energy for ASTM D256 Notched-Izod Impact samples were measured at 23° C. and 5 lb_{f}/ft pendulum energy. The results are illustrated in FIGS. 15 and 16. While there is no statistical difference seen, the average impact energy of the first pass samples, i.e., the samples having one heat history, are about 100 joules per meter (J/m) higher than that of the second pass samples.

Dynatup disks were molded for ASTM D3763 Multiaxial Impact (MAI) testing. The disks were measured at 23° C. and an impact velocity of 3.2 meters per second. The results illustrated in FIGS. 17 and 18 show the MAI at maximum deflection for the various sample formulations. The energy at maximum deflection for all recycled formulations (Samples 1-8) are also similar to that of the virgin (Sample 0).

The percent ductility for both the IZOD impact and the MAI test is represented in FIGS. 15 and 17, respectively. All formulations retained 100% ductility even after 2 passes through the heat cycle.

As can be seen from all of the experimental data above, the thermoplastic multilayer films as disclosed herein comprise resin layers that are miscible when mixed together. As such, adding recycled content, as high as 20 weight percent, to the virgin base layer resin does not negatively impact the rheological, processing, or mechanical properties of the multilayer film.

Ranges disclosed herein are inclusive and combinable (e.g., ranges of “up to about 25 wt %, or, more specifically, about 5 wt % to about 20 wt %”, is inclusive of the endpoints and all intermediate values of the ranges of “about 5 wt % to about 25 wt %,” etc.). “Combination” is inclusive of blends, mixtures, alloys, reaction products, and the like. Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the state value and has the meaning dictated by context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and can or can not be present in other embodiments. In addition, it is to be understood that the described elements can be combined in any suitable manner in the various embodiments. As used herein, the terms sheet, film, plate, and layer, are used interchangeably, and are not intended to denote size.

Compounds are described using standard nomenclature. For example, any position not substituted by any indicated group is understood to have its valency filled by a bond as indicated, or a hydrogen atom. A dash (“—”) that is not between two letters or symbols is used to indicate a point of attachment for a substituent. For example, —CHO is attached through carbon of the carbonyl group. As used herein, the term “(meth)acrylate” encompasses both acrylate and methacrylate groups.

As used herein, the term “hydrocarbyl” refers broadly to a substituent comprising carbon and hydrogen, optional with at least one heteroatoms, for example, oxygen, nitrogen, halogen, or sulfur; “alkyl” refers to a straight or branched chain monovalent hydrocarbon group; “alkylene” refers to a straight or branched chain divalent hydrocarbon group; “alkylidene” refers to a straight or branched chain divalent hydrocarbon group, with both valences on a single common carbon atom; “alkenyl” refers to a straight or branched chain monovalent hydrocarbon group having at least two carbons joined by a carbon-carbon double bond; “cycloalkyl” refers to a non-aromatic monovalent monocyclic or multicylic hydrocarbon group having at least three carbon atoms, “cycloalkenyl” refers to a non-aromatic cyclic divalent hydrocarbon group having at least three carbon atoms, with at least one degree of unsaturation; “aryl” refers to an aromatic monovalent group containing only carbon in the aromatic ring or rings; “arylene” refers to an aromatic divalent group containing only carbon in the aromatic ring or rings; “alkylaryl” refers to an aryl group that has been substituted with an alkyl group as defined above, with 4-methylphenyl being an exemplary alkylaryl group; “arylalkyl” refers to an alkyl group that has been substituted with an aryl group as defined above, with benzyl being an exemplary arylalkyl group; “acyl” refers to an alkyl group as defined above with the indicated number of carbon atoms attached through a carbonyl carbon bridge (—C(═O)—); “alkoxy” refers to an alkyl group as defined above with the indicated number of carbon atoms attached through an oxygen bridge (—O—); and “aryloxy” refers to an aryl group as defined above with the indicated number of carbon atoms attached through an oxygen bridge (—O—).

Unless otherwise indicated, each of the foregoing groups can be unsubstituted or substituted, provided that the substitution does not significantly adversely affect synthesis, stability, or use of the compound. The term “substituted”0 as used herein means that at least one hydrogen on the designated atom or group is replaced with another group, provided that the designated atom's normal valence is not exceeded. When the substituent is oxo (i.e., ═O), then two hydrogens on the atom are replaced. Combinations of substituents and/or variables are permissible provided that the substitutions do not significantly adversely affect synthesis or use of the compound.

Exemplary groups that can be present on a “substituted” position include, but are not limited to, halogen; cyano; hydroxyl; nitro; azido; alkanoyl (such as a C₂-C₆ alkanoyl group such as acyl or the like); carboxamido; alkyl groups (typically having 1 to about 8 carbon atoms, or 1 to about 6 carbon atoms); cycloalkyl groups, alkenyl and alkynyl groups (including groups having at least one unsaturated linkages and from 2 to about 8, or 2 to about 6 carbon atoms); alkoxy groups having at least one oxygen linkages and from 1 to about 8, or from 1 to about 6 carbon atoms; aryloxy such as phenoxy; alkylthio groups including those having at least one thioether linkages and from 1 to about 8 carbon atoms, or from 1 to about 6 carbon atoms; alkylsulfinyl groups including those having at least one sulfinyl linkages and from 1 to about 8 carbon atoms, or from 1 to about 6 carbon atoms; alkylsulfonyl groups including those having at least one sulfonyl linkages and from 1 to about 8 carbon atoms, or from 1 to about 6 carbon atoms; aminoalkyl groups including groups having at least one N atoms and from 1 to about 8, or from 1 to about 6 carbon atoms; aryl having 6 or more carbons and at least one rings, (e.g., phenyl, biphenyl, naphthyl, or the like, each ring either substituted or unsubstituted aromatic); arylalkyl having 1 to 3 separate or fused rings and from 6 to about 18 ring carbon atoms, with benzyl being an exemplary arylalkyl group; or arylalkoxy having 1 to 3 separate or fused rings and from 6 to about 18 ring carbon atoms, with benzyloxy being an exemplary arylalkoxy group.

All cited patents, patent applications, and other references are incorporated herein by reference in their entirety. However, if a term in the present application contradicts or conflicts with a term in the incorporated reference, the term from the present application tales precedence over the conflicting term from the incorporated reference.

While the invention has been described with reference to a preferred embodiment, it will be understood by those skilled in the art that various changes can be made and equivalents can be substituted for elements thereof without departing from the scope of the invention. In addition, many modifications can be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

1. A method for making a multilayer film, comprising:
combining a base layer composition with a recycle composition to form a mixture, wherein the recycle composition comprises the base layer composition and an outer layer composition;
forming a base layer from the mixture;
disposing an outer layer adjacent to the base layer to form the multilayer film; and
recycling a material to form the recycle composition, wherein the material is selected from the group consisting of scrap base layer, scrap outer layer, scrap multilayer film, and combinations comprising at least one of the foregoing;
wherein the outer layer comprises the outer layer composition which comprises resorcinol arylate polyester chain members; and
wherein the base layer composition comprises
about 2 wt % to about 98 wt % of an aromatic carbonate polymer; and
about 2 wt % to about 98 wt % of a second polymer derived from a glycol portion and an acid portion, wherein the glycol portion comprises 1,4 cyclohexanedimethanol and ethylene glycol wherein a molar ratio of the 1,4 cyclohexanedimethanol to the ethylene glycol is about 1:1 to about 4:1, and wherein the acid portion comprises an aromatic dicarboxylic acid selected from the group consisting essentially of terphthalic acid, isophthalic acid, and combinations comprising at least one of the foregoing acids.

2. The method of claim 1, wherein the aromatic carbonate polymer is a carbonate of bisphenol-A, and wherein the second polymer is a polyester copolymer.

3. The method of claim 1, wherein the outer layer has an outermost surface comprising a sublayer comprising the resorcinol arylate polyester chain members.

4. The method of claim 1, wherein disposing the outer layer adjacent to the base layer further comprises co-extruding the outer layer and the base layer.

5. The method of claim 1, wherein the mixture comprises about 1 wt % to about 20 wt % recycle composition, based upon a total weight of the mixture.

6. The method of claim 1, wherein the mixture comprises about 5 wt % to about 20 wt % recycle composition.

7. The method of claim 1, wherein the mixture comprises about 10 wt % to about 20 wt % recycle composition.

8. The method of claim 1, wherein
the aromatic carbonate polymer is present in the base layer in an amount of about 2 wt % to about 85 wt %; and
the second polymer is present in the base layer in an amount of about 15 wt % to about 98 wt %.

9. An article, comprising:
a multilayer film comprising
an outer layer comprising a polymer comprising resorcinol arylate polyester chain members; and
a base layer comprising
about 2 wt % to about 98 wt % of an aromatic carbonate polymer; and
about 2 wt % to about 98 wt % of a second polymer derived from a glycol portion and an acid portion, wherein the glycol portion comprises 1,4 cyclohexanedimethanol and ethylene glycol wherein a molar ratio of the 1,4 cyclohexanedimethanol to the ethylene glycol is about 1:1 to about 4:1, and wherein the acid portion comprises an aromatic dicarboxylic acid selected from the group consisting essentially of terphthalic acid, isophthalic acid, and combinations comprising at least one of the foregoing acids; and
a substrate adhered to the base layer, wherein the substrate comprises a material selected from the group consisting of polyurethane, polycarbonate, and combinations comprising at least one of the foregoing.

10. The article of claim 9, wherein the material comprises a polycarbonate blend selected from the group consisting of PC/PBT, PC/ASA, PC/ABS, and combinations comprising at least one of the foregoing.

11. The article of claim 9, wherein the material comprises foamed polyurethane.

12. The article of claim 9, wherein the substrate further comprises glass fibers.

13. The article of claim 9, wherein
the aromatic carbonate polymer is present in the base layer in an amount of about 2 wt % to about 85 wt %; and
the second polymer is present in the base layer in an amount of about 15 wt % to about 98 wt %.

14. A method of making an article, comprising:
placing a multilayer film into a mold so that a cavity is formed behind the multilayer film, wherein the multilayer film comprises
an outer layer comprising resorcinol arylate polyester chain members; and
a base layer comprising
about 2 wt % to about 98 wt % of an aromatic carbonate polymer; and
about 2 wt % to about 98 wt % of a second polymer derived from a glycol portion and an acid portion, wherein the glycol portion comprises 1,4 cyclohexanedimethanol and ethylene glycol wherein a molar ratio of the 1,4 cyclohexanedimethanol to the ethylene glycol is about 1:1 to about 4:1, and wherein the acid portion comprises an aromatic dicarboxylic acid selected from the group consisting essentially of terphthalic acid, isophthalic acid, and combinations comprising at least one of the foregoing acids;
placing a substrate into the cavity, wherein the substrate comprises a material selected from the group consisting of polyurethane, polycarbonate, and combinations comprising at least one of the foregoing; and
adhering the base layer to the substrate to form the article.

15. The method of claim 13, wherein the substrate is injected into the cavity.

16. The method of claim 13, further comprising co-extruding the multilayer film.

17. The method of claim 16, further comprising
thermoforming the co-extruded multilayer film to form a thermoformed film;
reaction injection molding the substrate in a mold;
placing the thermoformed film in a mold such that the base layer is between the substrate and the outer layer;
forming the article.
